(19) United States
(12) Patent Application Publication
(10) Pub. No.: US 2023/0039220 A1
(43) Pub. Date: Feb. 9, 2023

(54) MEASUREMENT REPORT TRIGGERED BY BEAM SWITCH INDICATION

(71) Applicant: QUALCOMM Incorporated, San Diego, CA (US)

(72) Inventors: Tianyang BAI, Somerville, NJ (US); Yan ZHOU, San Diego, CA (US); Tao LUO, San Diego, CA (US); Junyi LI, Fairless Hills, PA (US)

(21) Appl. No.: 17/805,965

(22) Filed: Jun. 8, 2022

Related U.S. Application Data
(60) Provisional application No. 63/260,030, filed on Aug. 6, 2021.
(60) Provisional application No. 63/260,036, filed on Aug. 6, 2021.

(51) Int. Cl. H04W 24/10; H04L 5/00; H04W 72/04; H04B 7/08

(52) U.S. Cl. CPC H04W 24/10; H04L 5/0051; H04W 72/046; H04W 72/0446; H04W 72/042; H04L 5/0053; H04B 7/088

(57) ABSTRACT

Various aspects of the present disclosure generally relate to wireless communication. In some aspects, a user equipment (UE) may receive an indication to switch a beam used by the UE, wherein the indication triggers at least one of a reference signal for a beam measurement or a transmission of a measurement report, based at least in part on an association of the beam with the reference signal or the measurement report. The UE may receive the reference signal associated with the beam measurement based at least in part on receiving the indication to switch the beam. The UE may transmit, using one or more transmission parameters, the measurement report indicating a measurement of the reference signal, wherein the one or more transmission parameters are based at least in part on receiving the indication to switch the beam. Numerous other aspects are described.

### CROSS-REFERENCE TO RELATED APPLICATIONS

This patent application claims priority to U.S. Provisional Patent Application No. 63/260,030, filed on Aug. 6, 2021, entitled “MEASUREMENT REPORT TRIGGERED BY BEAM SWITCH INDICATION,” and assigned to the assignee hereof; and to U.S. Provisional Patent Application No. 63/260,036, filed on Aug. 6, 2021, entitled “DOWNLINK CONTROL INFORMATION TRIGGERING TRANSMISSION CONFIGURATION INDICATOR UPDATE AND BEAM MEASUREMENT OR REPORT,” and assigned to the assignee hereof. The disclosure of the prior applications are considered part of and are incorporated by reference into this patent application.

### FIELD OF THE DISCLOSURE

Aspects of the present disclosure generally relate to wireless communication and to techniques and apparatuses for a measurement report triggered by a beam switch indication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Techniques described herein provide for improved resource utilization, improved beam management, and reduced latency associated with initiating beam measurement and/or associated measurement reports, among other examples. For example, some techniques described herein enable a single downlink message to trigger a beam switch and to trigger a beam measurement and/or associated measuring reporting. It may be beneficial for a user equipment (UE) to measure a beam after a beam switch or a beam update. For example, the UE may measure and/or report measurements of a new beam (e.g., after receiving a beam switch indication or a beam update) to a base station to improve beam management. This may conserve resources that would have otherwise been used to trigger the beam switch or beam update and to trigger the beam measurement and/or associated measuring reporting in separate messages. Some techniques described herein enable the UE to identify a configuration, a timing, and/or transmission parameters to be used to transmit the measurement report that is triggered by the beam switch indication. Therefore, the UE may transmit a measurement report (e.g., using the identified transmission parameters) based at least in part on receiving the beam switch indication. This may reduce a latency associated with transmitting the measurement report. Additionally, this may improve beam management because the UE is triggered to perform beam measurement and/or associated measurement reporting after changing a beam used by the UE.

Additionally, some techniques described herein enable the UE to identify an association between a reference signal for measurement and/or measurement report, and the beam switch indication, such that the reference signal and/or measurement report can be identified based at least in part on the beam switch indication. For example, a signaling-based approach is provided, in which a base station may provide configuration information indicating the association. As another example, a rule-based approach is provided, where the UE is configured, pre-configured, or hardcoded with a rule indicating the association. The signaling-based approach may provide flexible configuration of triggered actions and the indicated beam (for example, the signaling-based approach can trigger the UE to measure reference signals for neighboring beams as well as an activated beam). The rule-based approach reduces overhead and does not require the definition of an information element to define the association between a beam and a triggered action (such as a measurement of a reference signal or transmission of a measurement report).

Some aspects described herein relate to a method of wireless communication performed by a UE. The method may include receiving an indication to switch a beam used by the UE, wherein the indication triggers a beam measurement and a transmission of a measurement report. The method may include receiving a reference signal associated with the beam measurement based at least in part on receiving the indication to switch the beam. The method may include transmitting, using one or more transmission parameters, the measurement report indicating a measurement of the reference signal, wherein the one or more transmission parameters are based at least in part on receiving the indication to switch the beam.

Some aspects described herein relate to a method of wireless communication performed by a base station. The method may include transmitting, to a UE, an indication to switch a beam used by the UE, wherein the indication triggers a beam measurement and a transmission of a measurement report. The method may include transmitting a reference signal associated with the beam measurement based at least in part on transmitting the indication to switch the beam. The method may include receiving, using one or more transmission parameters, the measurement report indicating a measurement of the reference signal, wherein the one or more transmission parameters are based at least in part on the indication to switch the beam.

Some aspects described herein relate to a UE for wireless communication. The user equipment may include a memory and one or more processors coupled to the memory. The one or more processors may be configured to receive an indication to switch a beam used by the UE, wherein the indication triggers a beam measurement and a transmission of a measurement report. The one or more processors may be configured to receive a reference signal associated with the beam measurement based at least in part on receiving the indication to switch the beam. The one or more processors may be configured to transmit, using one or more transmission parameters, the measurement report indicating a measurement of the reference signal, wherein the one or more transmission parameters are based at least in part on receiving the indication to switch the beam.

Some aspects described herein relate to a base station for wireless communication. The base station may include a memory and one or more processors coupled to the memory. The one or more processors may be configured to transmit, to a UE, an indication to switch a beam used by the UE, wherein the indication triggers a beam measurement and a transmission of a measurement report. The one or more processors may be configured to transmit a reference signal associated with the beam measurement based at least in part on transmitting the indication to switch the beam. The one or more processors may be configured to receive, using one or more transmission parameters, the measurement report indicating a measurement of the reference signal, wherein the one or more transmission parameters are based at least in part on the indication to switch the beam.

Some aspects described herein relate to a non-transitory computer-readable medium that stores a set of instructions for wireless communication by a UE. The set of instructions, when executed by one or more processors of the UE, may cause the UE to receive an indication to switch a beam used by the UE, wherein the indication triggers a beam measurement and a transmission of a measurement report. The set of instructions, when executed by one or more processors of the UE, may cause the UE to receive a reference signal associated with the beam measurement based at least in part on receiving the indication to switch the beam. The set of instructions, when executed by one or more processors of the UE, may cause the UE to transmit, using one or more transmission parameters, the measurement report indicating a measurement of the reference signal, wherein the one or more transmission parameters are based at least in part on receiving the indication to switch the beam.

Some aspects described herein relate to a non-transitory computer-readable medium that stores a set of instructions for wireless communication by a base station. The set of instructions, when executed by one or more processors of the base station, may cause the base station to transmit, to a UE, an indication to switch a beam used by the UE, wherein the indication triggers a beam measurement and a transmission of a measurement report. The set of instructions, when executed by one or more processors of the base station, may cause the base station to transmit a reference signal associated with the beam measurement based at least in part on transmitting the indication to switch the beam. The set of instructions, when executed by one or more processors of the base station, may cause the base station to receive, using one or more transmission parameters, the measurement report indicating a measurement of the reference signal, wherein the one or more transmission parameters are based at least in part on the indication to switch the beam.

Some aspects described herein relate to an apparatus for wireless communication. The apparatus may include means for receiving an indication to switch a beam used by the apparatus, wherein the indication triggers a beam measurement and a transmission of a measurement report. The apparatus may include means for receiving a reference signal associated with the beam measurement based at least in part on receiving the indication to switch the beam. The apparatus may include means for transmitting, using one or more transmission parameters, the measurement report indicating a measurement of the reference signal, wherein the one or more transmission parameters are based at least in part on receiving the indication to switch the beam.

Some aspects described herein relate to an apparatus for wireless communication. The apparatus may include means for transmitting, to a UE, an indication to switch a beam used by the UE, wherein the indication triggers a beam measurement and a transmission of a measurement report. The apparatus may include means for transmitting a reference signal associated with the beam measurement based at least in part on transmitting the indication to switch the beam. The apparatus may include means for receiving, using one or more transmission parameters, the measurement report indicating a measurement of the reference signal, wherein the one or more transmission parameters are based at least in part on the indication to switch the beam.

Some aspects described herein relate to a method of wireless communication performed by a UE. The method may include receiving an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report. The method may include transmitting the measurement report indicating a measurement of the reference signal if the measurement report is triggered.

Some aspects described herein relate to a method of wireless communication performed by a base station. The method may include transmitting an indication to switch a beam used by a UE, wherein the indication triggers at least one of a reference signal for measurement or a transmission of a measurement report, wherein the reference signal or the transmission of the measurement report is triggered based at least in part on an association of the beam with the reference signal or the measurement report. The method may include transmitting the reference signal based at least in part on transmitting the indication to switch the beam if the reference signal for measurement is triggered. The method may include receiving the measurement report indicating a measurement of the reference signal if the measurement report is triggered.

Some aspects described herein relate to a UE for wireless communication. The user equipment may include a memory and one or more processors coupled to the memory. The one or more processors may be configured to receive an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report. The one or more processors may be configured to transmit the measurement report indicating a measurement of the reference signal if the measurement report is triggered.

Some aspects described herein relate to a base station for wireless communication. The base station may include a memory and one or more processors coupled to the memory. The one or more processors may be configured to transmit an indication to switch a beam used by a UE, wherein the indication triggers at least one of a reference signal for measurement or a transmission of a measurement report, wherein the reference signal or the transmission of the measurement report is triggered based at least in part on an association of the beam with the reference signal or the measurement report. The one or more processors may be configured to transmit the reference signal based at least in part on transmitting the indication to switch the beam if the reference signal for measurement is triggered. The one or more processors may be configured to receive the measurement report indicating a measurement of the reference signal if the measurement report is triggered.

Some aspects described herein relate to a non-transitory computer-readable medium that stores a set of instructions for wireless communication by a UE. The set of instructions, when executed by one or more processors of the UE, may cause the UE to receive an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report. The set of instructions, when executed by one or more processors of the UE, may cause the UE to transmit the measurement report indicating a measurement of the reference signal if the measurement report is triggered.

Some aspects described herein relate to a non-transitory computer-readable medium that stores a set of instructions for wireless communication by a base station. The set of instructions, when executed by one or more processors of the base station, may cause the base station to transmit an indication to switch a beam used by a UE, wherein the indication triggers at least one of a reference signal for measurement or a transmission of a measurement report, wherein the reference signal or the transmission of the measurement report is triggered based at least in part on an association of the beam with the reference signal or the measurement report. The set of instructions, when executed by one or more processors of the base station, may cause the base station to transmit the reference signal based at least in part on transmitting the indication to switch the beam if the reference signal for measurement is triggered. The set of instructions, when executed by one or more processors of the base station, may cause the base station to receive the measurement report indicating a measurement of the reference signal if the measurement report is triggered.

Some aspects described herein relate to an apparatus for wireless communication. The apparatus may include means for receiving an indication to switch a beam used by the apparatus, wherein the indication triggers at least one of a reference signal for measurement or a transmission of a measurement report, wherein the reference signal or the transmission of the measurement report is triggered based at least in part on an association of the beam with the reference signal or the measurement report. The apparatus may include means for transmitting the measurement report indicating a measurement of the reference signal if the measurement report is triggered.

Some aspects described herein relate to an apparatus for wireless communication. The apparatus may include means for transmitting an indication to switch a beam used by a UE, wherein the indication triggers at least one of a reference signal for measurement or a transmission of a measurement report, wherein the reference signal or the transmission of the measurement report is triggered based at least in part on an association of the beam with the reference signal or the measurement report. The apparatus may include means for transmitting the reference signal based at least in part on transmitting the indication to switch the beam if the reference signal for measurement is triggered. The apparatus may include means for receiving the measurement report indicating a measurement of the reference signal if the measurement report is triggered.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating examples of channel state information (CSI) reference signal (CSI-RS) beam management procedures, in accordance with the present disclosure.

FIG. 5 is a diagram illustrating an example associated with configuration of a beam switch indication to trigger a reference signal for measurement or a measurement report, in accordance with the present disclosure.

FIG. 6 is a diagram illustrating an example associated with a rule-based approach for a beam switch indication to trigger a reference signal for measurement or a measurement report, in accordance with the present disclosure.

FIG. 7 is a diagram illustrating an example associated with a measurement report triggered by a beam switch indication, in accordance with the present disclosure.

FIGS. 8-11 are diagrams illustrating example processes associated with a measurement report triggered by a beam switch indication, in accordance with the present disclosure.

FIGS. 12 and 13 are diagrams of example apparatuses for wireless communication, in accordance with the present disclosure.

### DETAILED DESCRIPTION

Techniques described herein provide for improved resource utilization, improved beam management, and reduced latency associated with initiating beam measurement and/or associated measurement reports, among other examples. For example, some techniques described herein enable a single downlink message to trigger a beam switch and to trigger a beam measurement and/or associated measuring reporting. It may be beneficial for a user equipment (UE) to measure a beam after a beam switch or a beam update. For example, the UE may measure and/or report measurements of a new beam (e.g., after receiving a beam switch indication or a beam update) to a base station to improve beam management. This may conserve resources that would have otherwise been used to trigger the beam switch or beam update and to trigger the beam measurement and/or associated measuring reporting in separate messages. Some techniques described herein enable the UE to identify a configuration, a timing, and/or transmission parameters to be used to transmit the measurement report that is triggered by the beam switch indication. Therefore, the UE may transmit a measurement report (e.g., using the identified transmission parameters) based at least in part on receiving the beam switch indication. This may reduce a latency associated with transmitting the measurement report. Additionally, this may improve beam management because the UE is triggered to perform beam measurement and/or associated measurement reporting after changing a beam used by the UE.

Additionally, some techniques described herein enable the UE to identify an association between a reference signal for measurement and/or measurement report, and the beam switch indication, such that the reference signal and/or measurement report can be identified based at least in part on the beam switch indication. For example, a signaling-based approach is provided, in which a base station may provide configuration information indicating the association. As another example, a rule-based approach is provided, where the UE is configured, pre-configured, or hardcoded with a rule indicating the association. The signaling-based approach may provide flexible configuration of triggered actions and the indicated beam (for example, the signaling-based approach can trigger the UE to measure reference signals for neighboring beams as well as an activated beam). The rule-based approach reduces overhead and does not require the definition of an information element to define the association between a beam and a triggered action (such as a measurement of a reference signal or transmission of a measurement report).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

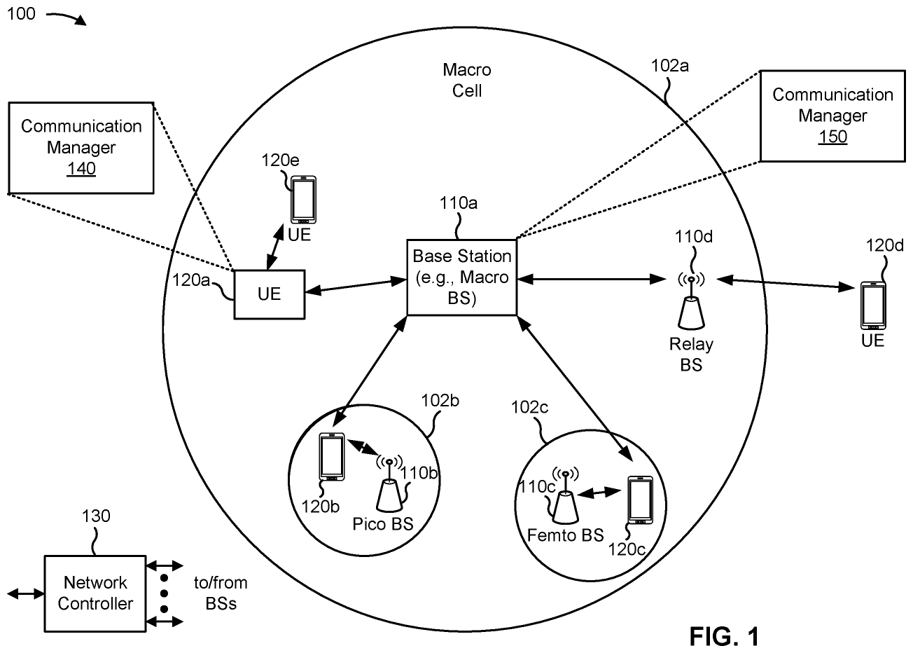

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication to switch a beam used by the UE 120, wherein the indication triggers a beam measurement and a transmission of a measurement report; receive a reference signal associated with the beam measurement based at least in part on receiving the indication to switch the beam; and transmit, using one or more transmission parameters, the measurement report indicating a measurement of the reference signal, wherein the one or more transmission parameters are based at least in part on receiving the indication to switch the beam. Additionally, or alternatively, the communication manager 140 may perform one or more other operations described herein.

In some aspects, the base station 110 may include a communication manager 150. As described in more detail elsewhere herein, the communication manager 150 may transmit, to a UE 120, an indication to switch a beam used by the UE, wherein the indication triggers a beam measurement and a transmission of a measurement report; transmit a reference signal associated with the beam measurement based at least in part on transmitting the indication to switch the beam; and receive, using one or more transmission parameters, the measurement report indicating a measurement of the reference signal, wherein the one or more transmission parameters are based at least in part on the indication to switch the beam. Additionally, or alternatively, the communication manager 150 may perform one or more other operations described herein.

As indicated above, FIG. 1 is provided as an example. Other examples may differ from what is described with regard to FIG. 1.

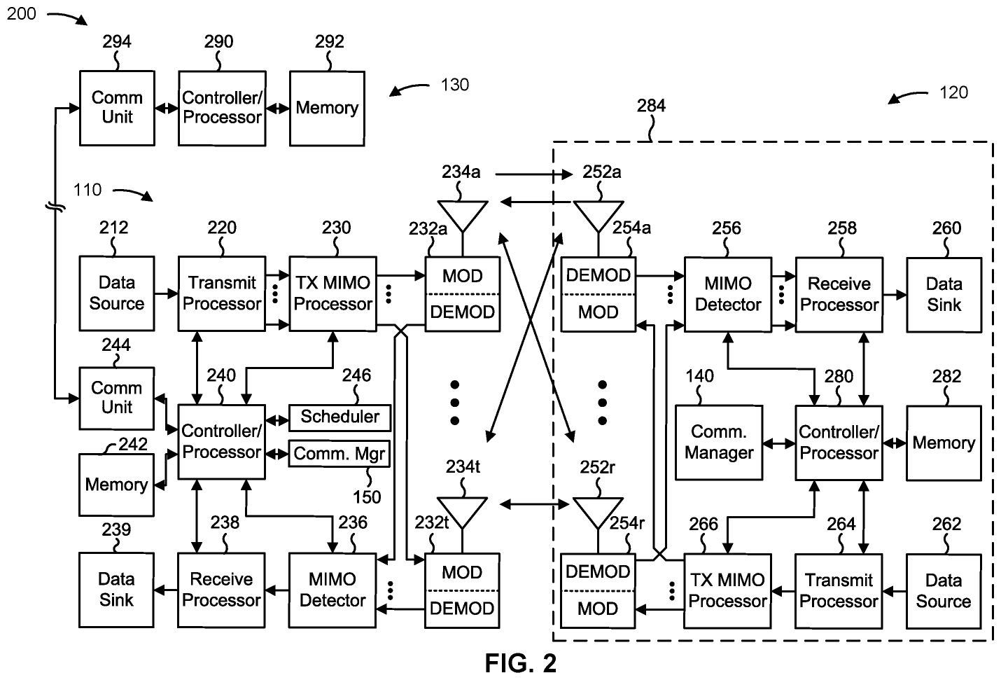

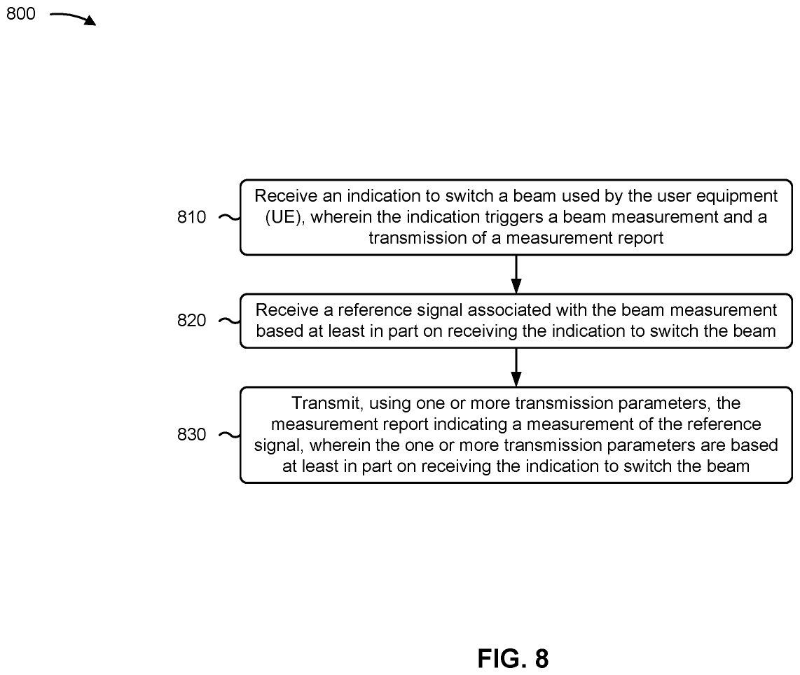

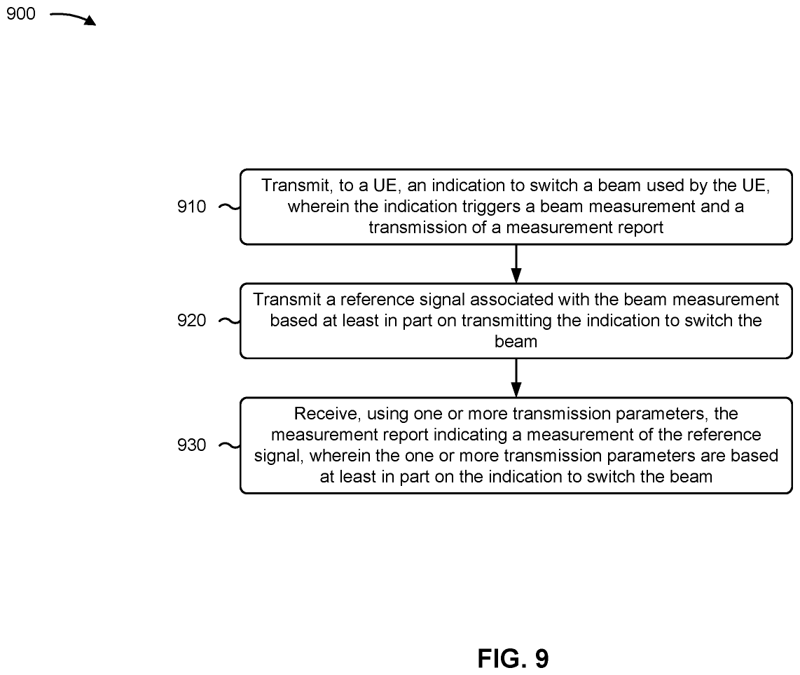

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1). The components shown in FIG. 2 are described in more detail in connection with FIG. 8 (for the UE 120) and FIG. 9 (for the base station 110).

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

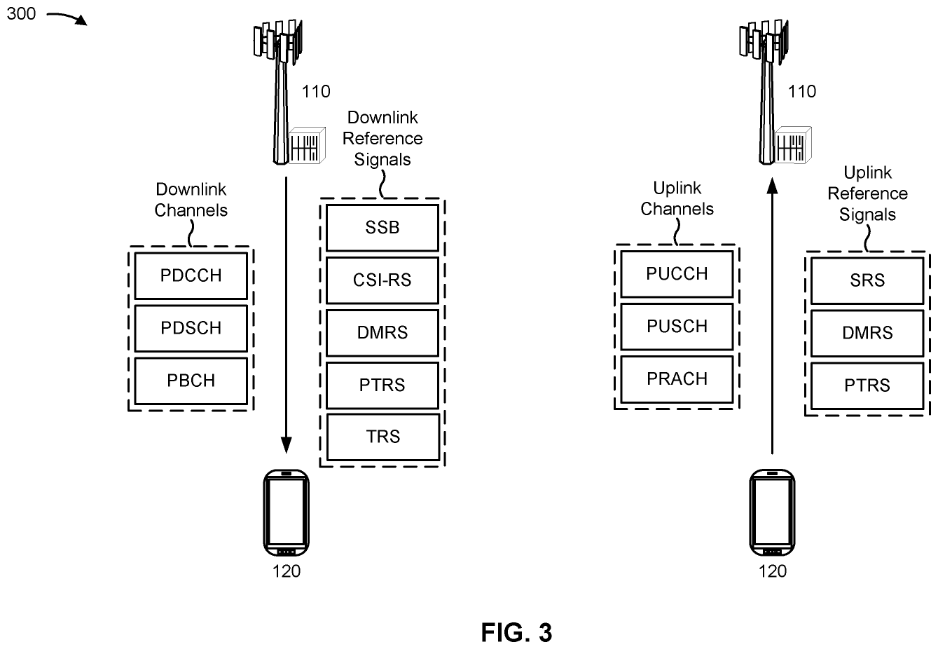

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), and/or a tracking reference signal (TRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A TRS may be a downlink reference signal and may carry information used to assist in time domain and frequency domain tracking. The TRS may be used to track transmission path delay spread and/or Doppler spread. A TRS may be UE-specific. In some examples, a TRS may be transmitted in a TRS burst. A TRS burst may consist of four OFDM symbols in two consecutive slots. In some examples, a TRS may be associated with one or more CSI-RS configurations. For example, a TRS burst may use one or more CSI-RS resources.

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

In some cases, the UE 120 may be configured to measure one or more reference signals. For example, the UE 120 may receive a downlink reference signal and may measure a parameter (e.g., a signal strength, a signal quality, an RSRP, and/or a reference signal received quality (RSRQ), among other examples) of the downlink reference signal. The UE 120 may be configured to transmit, to the base station 110, a measurement report indicating a measurement of the downlink reference signal. The base station 110 may use the measurement(s) indicated in the measurement report for beam management determinations, handover determinations, and/or other link management determinations.

As indicated above, FIG. 3 is provided as an example. Other examples may differ from what is described with regard to FIG. 3.

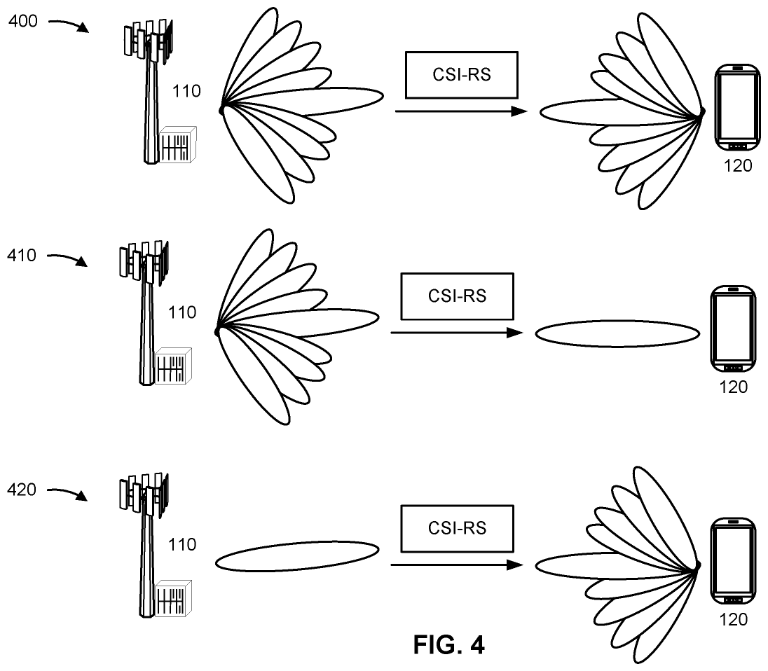

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a base station 110 in a wireless network (e.g., wireless network 100). However, the devices shown in FIG. 4 are provided as examples, and the wireless network may support communication and beam management between other devices (e.g., between a UE 120 and a base station 110 or TRP, between a mobile termination node and a control node, between an IAB child node and an IAB parent node, and/or between a scheduled node and a scheduling node). In some aspects, the UE 120 and the base station 110 may be in a connected state (e.g., a radio resource control (RRC) connected state).

As shown in FIG. 4, example 400 may include a base station 110 and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 400 has been described in connection with CSI-RSs, the first beam management process may also use SSBs for beam management in a similar manner as described above.

As shown in FIG. 4, example 410 may include a base station 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As described above, a beam measurement and/or associated reporting may be triggered by a message from the base station 110 (e.g., a DCI or a MAC-CE). For example, the base station 110 may trigger the UE 120 to perform CSI-RS measurement and reporting, P1 CSI-RS beam management measurement and reporting, P2 CSI-RS beam management measurement and reporting, P3 CSI-RS beam management measurement and reporting, and/or TRS measurement and reporting, among other examples.

The UE 120 may transmit measurement reports using an uplink control channel (e.g., the PUCCH) and/or an uplink shared channel (e.g., the PUSCH). The measurement reports may be configured to be aperiodic, semi-persistent, and/or periodic. For example, the UE 120 may transmit aperiodic and/or semi-persistent measurement reports using the uplink shared channel (e.g., the PUSCH). The UE 120 may transmit semi-persistent and/or periodic measurement reports using the uplink control channel (e.g., the PUCCH). The UE 120 may identify resources to be used for transmitting the measurement based at least in part on a scheduling method of measurement report (e.g., periodic, semi-persistent, and/or periodic) and/or on the channel to be used to transmit the measurement report. For example, one or more transmission parameters (e.g., a time domain resource allocation (TDRA), a frequency domain resource allocation (FDRA), an MCS, and/or a hybrid automatic repeat request (HARQ) process identifier, among other examples) for the measurement report may be configured in an RRC configuration. As used herein, “transmission parameter” may refer to a parameter to be used by a UE for a transmission of an uplink message. For example, a transmission parameter may include a TDRA, an FDRA, an MCS, a number of transmission layers (e.g., a rank), and/or a precoding matrix (e.g., a precoder), among other examples. For example, a CSI report configuration (e.g., a CSI reportConfig) may indicate a channel (e.g., the PUCCH or the PUSCH) associated with the CSI report configuration, a scheduling method associated with the CSI report configuration (e.g., periodic, semi-persistent, and/or periodic), and/or one or more resources (e.g., CSI-RS resources) to be measured (e.g., in a reportQuantity field), among other examples.

In some cases, other transmission parameters associated with the measurement report may be indicated by, or based at least in part on, the message that triggers the beam measurement and/or the measurement report. For example, a DCI message and/or a MAC-CE message may trigger the UE 120 to measure one or more beams and to transmit a measurement report. The message may indicate a trigger state (e.g., which may indicate one or more CSI report configurations) and/or may indicate a CSI report configuration. Additionally, the message may indicate one or more transmission parameters associated with the measurement report. For example, the message may indicate an amount of time between the message and a time at which a reference signal (e.g., a CSI-RS) that is to be measured by the UE 120 is transmitted by the base station 110. The message may indicate an amount of time between the message (or an ACK feedback associated with the message) and a time at which the measurement report is to be transmitted by the UE 120. For example, a DCI message (e.g., that triggers the beam measurement and/or the measurement report) may indicate a timing offset (e.g., a slot offset) between the DCI and the transmission time of the measurement report (e.g., by indicating an entry in a TDRA table via a reportslotoffsetlist field in the DCI). Additionally, the DCI may indicate a resource (e.g., a PUSCH resource) and/or an MCS to be used for the measurement report.

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

In some cases, a base station may update a beam to be used by a UE. For example, the base station may transmit, to the UE, an indication to switch a beam used by the UE to a new beam. As used herein, a message that indicates that the UE is to switch a beam used by the UE may be referred to as a “beam switch indication,” a “beam indication,” and/or a “transmission configuration indicator (TCI) state update,” among other examples. For example, the base station may indicate a new beam to be used by the UE using a DCI message and/or a MAC-CE message, among other examples. In some examples, a format of DCI that indicates a beam switch or a beam update (e.g., for a downlink beam to be used by the UE) may use a downlink DCI format. “Downlink DCI format” may refer to a DCI format that is associated with scheduling or indicating information associated with downlink messages (e.g., as defined, or otherwise fixed, by a wireless communication standard, such as the 3GPP). Examples of downlink DCI formats may include a DCI format 1_0, a DCI format 1_1, or a DCI format 12, among other examples (e.g., as defined, or otherwise fixed, by a wireless communication standard, such as the 3GPP). “Uplink DCI format” may refer to a DCI format that is associated with scheduling or indicating information associated with uplink messages (e.g., as defined, or otherwise fixed, by a wireless communication standard, such as the 3GPP). Examples of uplink DCI formats may include a DCI format 0_0, a DCI format 0_1, or a DCI format 02, among other examples. Downlink DCI formats and uplink DCI formats may include different fields and/or may convey different types of information. In some examples, the base station may indicate a beam switch or a beam update to the UE using DCI that uses a downlink DCI format.

As described above, beam measurement and/or associated reporting may be triggered by a base station by transmitting a message (e.g., DCI or MAC-CE) to the UE. For example, the base station may transmit a DCI message or a MAC-CE message triggering beam measurement and/or a measurement report. For example, for an aperiodic measurement report and/or a semi-persistent measurement report (e.g., to be transmitted on an uplink shared channel), the base station may transmit DCI (e.g., using an uplink DCI format) to trigger the measurement report. The DCI (e.g., using the uplink DCI format) may indicate a TDRA (e.g., by indicating a timing offset value), an FDRA, and/or an MCS, among other examples, to be used to transmit the measurement report. The timing offset value may indicate an amount of time between the DCI and the measurement report. The timing offset value may sometimes be referred to as a “K2” value. For a semi-persistent measurement report transmitted on an uplink control channel (e.g., the PUCCH), an RRC configuration may indicate the transmission parameters to be used for transmitting the measurement report. The base station 110 may activate a reporting configuration using a MAC-CE message. For example, an RRC configuration may indicate a timing of the reference signal to be measured (e.g., a CSI-RS) and a transmission time of the measurement report with reference to a time at which a reporting configuration indicated by a MAC-CE message is to take effect. The UE 120 may use information provided by the DCI message or the MAC-CE message to measure one or more beams and/or reference signals and to transmit one or more measurement reports.

In some cases, it may be beneficial for a UE to measure a beam after a beam switch or a beam update. For example, the UE may measure and/or report measurements of a new beam (e.g., after receiving a beam switch indication or a beam update) to the base station. The beam measurement and associated reporting may enable the base station to make improved beam management determinations. However, to trigger a beam switch or a beam update and to trigger the UE to transmit a measurement report, the base station may have to transmit multiple messages to the UE. For example, the base station may transmit a first message to trigger the beam switch or the beam update. The base station may transmit a second message to trigger the beam measurement and/or the measurement report. This may consume resources associated with transmitting the multiple messages to trigger a beam switch and to trigger the beam measurement and/or the measurement report.

Therefore, in some cases, the base station may trigger beam measurement and/or the measurement report using a message that triggers a beam switch or a beam update. For example, a message (e.g., a DCI or a MAC-CE) may indicate a TCI state for a new beam to be used by the UE. The TCI state may be associated with, or linked with, one or more trigger states, one or more reporting configurations, and/or one or more beam measurement procedures to be performed by the UE. Therefore, when the UE receives the message that triggers a beam switch or a beam update, the UE may also be triggered to perform beam measurements and/or to transmit a measurement report. This may conserve resources that would have otherwise been used to transmit multiple messages to trigger a beam switch and to trigger the beam measurement and/or the measurement report.

However, in some cases, a message (e.g., a DCI or a MAC-CE) used to trigger the beam switch may not include information (e.g., an indication of one or more transmission parameters) to be used for transmitting the measurement report. For example, a DCI format used to transmit DCI indicating the beam switch indication may not include fields for indicating one or more transmission parameters for the measurement report. For example, the DCI indicating the beam switch indication may use a downlink DCI format, whereas DCI triggering the measurement report may use an uplink DCI format. Additionally, in some cases, a timing (and/or other transmission parameters) for the measurement report may be based at least in part on an activation time of a MAC-CE message. However, the beam switch indication may be transmitted via DCI (e.g., rather than a MAC-CE message). Therefore, a timing of a transmission of the measurement report may not be indicated by the beam switch indication. As a result, the UE may be unable to determine one or more transmission parameters (e.g., a TDRA, an FDRA, and/or an MCS, among other examples) for the measurement report when the measurement report is triggered by a beam switch indication.

Some techniques and apparatuses described herein enable a transmission of a measurement report triggered by a beam switch indication. For example, one or more transmission parameters for the measurement report may be indicated by, or may be based at least in part on, a message (e.g., DCI) that indicates a beam switch for the UE. The transmission parameters may include a TDRA, an FDRA, an MCS, and/or a HARQ process identifier, among other examples. For example, a timing of the measurement report (e.g., a TDRA) may be based at least in part on a timing of a reception of the indication to switch the beam. In some aspects, a TDRA for the measurement report may be indicated by a timing offset value (e.g., a K2 value). The timing offset value may indicate an amount of time (e.g., a quantity slots) between the DCI indicating the beam switch and a set of resources (e.g., on a PUSCH or a PUCCH) that are to be used for transmitting the measurement report. In some aspects, the timing offset value for a measurement report transmitted using the uplink control channel (e.g., the PUCCH) may start from an ACK feedback message associated with the DCI indicating the beam switch. In some other aspects, the timing offset value for a measurement report transmitted using the uplink control channel (e.g., the PUCCH) may start from the DCI indicating the beam switch.

In some aspects, such as for a measurement report transmitted using the uplink shared channel (e.g., the PUSCH), the transmission parameter(s) for the measurement report may be indicated by the DCI indicating the beam switch. For example, in some aspects, the DCI may use an uplink DCI format (e.g., rather than a downlink DCI format) such that the DCI uses a format that includes fields for indicating the transmission parameter(s). In some aspects, the transmission parameter(s) may be indicated in an RRC configuration and may be indicated by the DCI indicating the beam switch. In some aspects, one or more transmission parameters for the measurement report may be based at least in part on a rule (e.g., defined in an RRC configuration or defined by a wireless communication standard, such as the 3GPP).

As a result, the UE may be enabled to identify a configuration, a timing, and/or transmission parameters to be used to transmit the measurement report that is triggered by the beam switch indication. For example, DCI indicating the beam switch indication may use a downlink DCI format and the UE may still be enabled to identify a TDRA, an FDRA, and/or an MCS for the measurement report (e.g., when the measurement report is transmitted on the PUSCH). Therefore, a beam switch or a beam update and a measurement report (e.g., a CSI measurement report) may be triggered in a single message (e.g., conserving resources of the UE and the base station) and the UE may be enabled to identify transmission parameters to be used to transmit the measurement report.

Additionally, a message (e.g., a DCI or a MAC-CE) may indicate a TCI state for a new beam to be used by the UE. The TCI state may be associated with, or linked with, one or more trigger states, one or more reporting configurations, and/or one or more beam measurement procedures to be performed by the UE. Therefore, when the UE receives the message that triggers a beam switch or a beam update, the UE may also be triggered to perform measurements and/or to transmit a measurement report. This may conserve resources that would have otherwise been used to transmit multiple messages to trigger a beam switch and to trigger the beam measurement and/or the measurement report. Some techniques and apparatuses described herein provide configuration or determination of an association between the TCI state and the measurement or the measurement report. For example, some techniques and apparatuses described herein provide a signaling-based approach, whereby the association is configured by signaling from a base station, which improves flexibility of the association. Some techniques and apparatuses described herein provide a rule-based approach, whereby the association is indicated by a rule, which reduces overhead associated with the association. In this way, the triggering of the measurement and/or the measurement report using the message that triggers the beam switch or the beam update is enabled. Furthermore, the techniques and apparatuses described herein can support configuration of multiple actions (that is, multiple measurements or measurement reports) for a single triggering message, which improves flexibility of concurrent triggering of beam switch and measurement or measurement reporting.

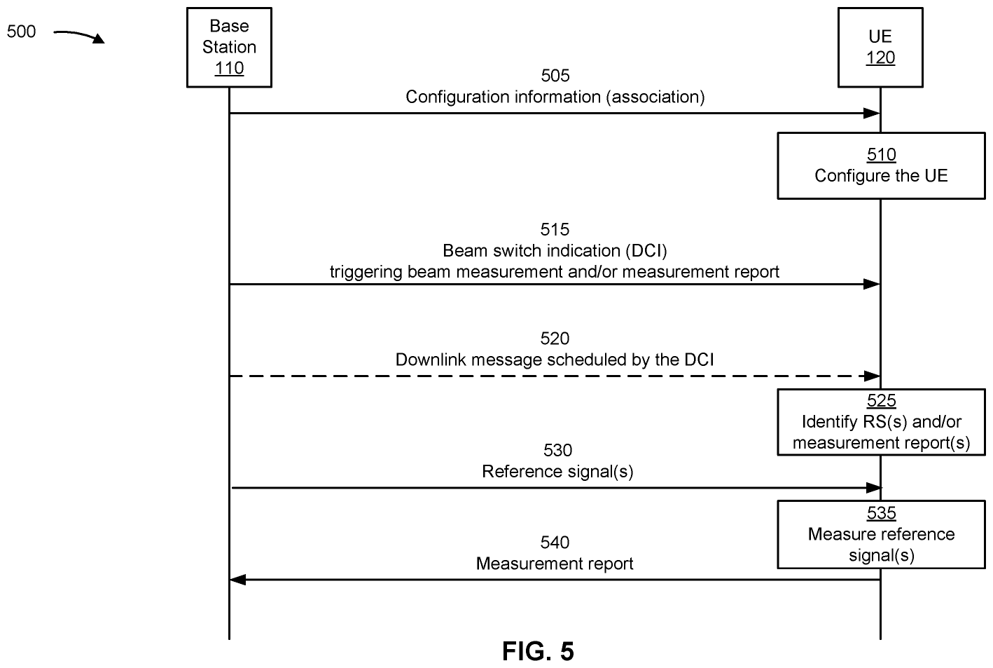

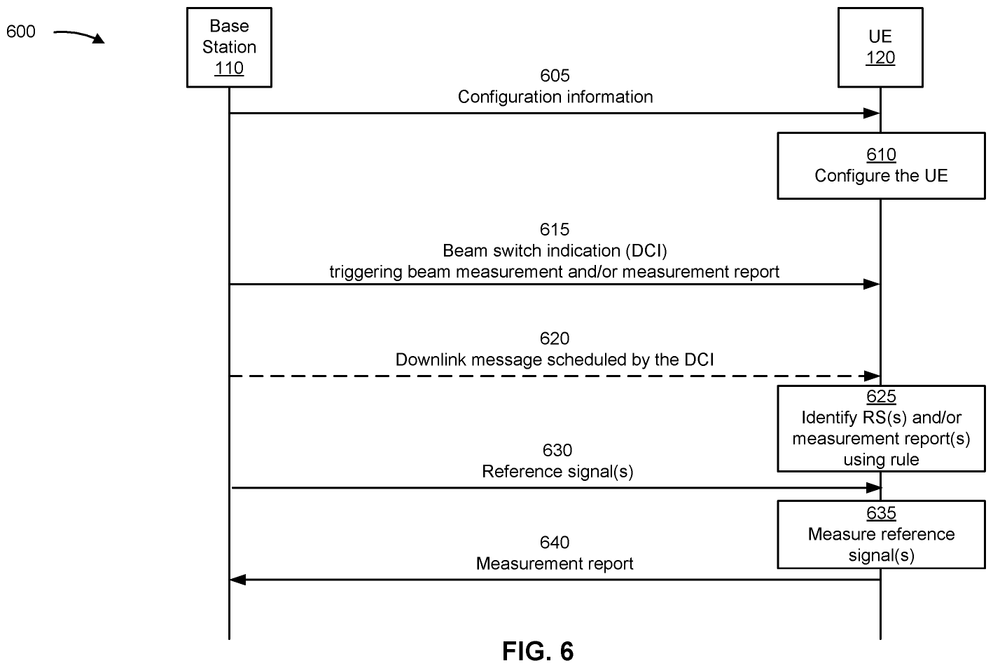

FIG. 5 is a diagram illustrating an example 500 associated with configuration of a beam switch indication to trigger a reference signal for measurement or a measurement report, in accordance with the present disclosure. As shown in FIG. 5, a base station 110 and a UE 120 may communicate with one another in a wireless network, such as the wireless network 100. FIG. 5 depicts an example associated with configuring an association between an indication to switch a beam and at least one of a reference signal for measurement or transmission of a measurement report (e.g., a CSI measurement report). For example, the indication may trigger the reference signal (or may trigger the UE 120 to measure a resource configured for the reference signal) or may trigger the UE 120 to transmit a measurement report regarding the measurement of the reference signal. The measurement report may be an aperiodic measurement report, a semi-persistent measurement report, and/or a periodic measurement report. The measurement report may be associated with an uplink control channel (e.g., the measurement report may be configured to be transmitted on the PUCCH). In some other aspects, the measurement report may be associated with an uplink shared channel (e.g., the measurement report may be configured to be transmitted on the PUSCH). In example 500, the association between the indication and the reference signal or the measurement report is configured (such as via signaling from the base station 110). For an example where the association is based at least in part on a rule, refer to the description accompanying FIG. 6.

As shown by reference number 505, the base station 110 may transmit, and the UE 120 may receive, configuration information. In some aspects, the UE 120 may receive configuration information from another device (e.g., from another base station or another UE). In some aspects, the UE 120 may receive the configuration information via RRC signaling and/or MAC signaling (e.g., MAC-CEs). In some aspects, the configuration information may be updated by MAC signaling, or DCI. In some aspects, the configuration information may include an indication of one or more configuration parameters (e.g., already known to the UE 120) for selection by the UE 120 and/or explicit configuration information for the UE 120 to use to configure the UE 120. The configuration information may indicate an association (e.g., a linkage) between a beam (such as a TCI state) and one or more RSs for measurement. Additionally, or alternatively, the configuration information may indicate an association (e.g., a linkage) between a beam (such as a TCI state) and one or more measurement reports, as described below. Thus, a signaling-based approach can be used to indicate the association used to trigger the beam.

In some aspects, the configuration information may indicate that one or more features are enabled for the UE 120 associated with measurement procedures and/or measurement reports that are triggered by beam switch indications. For example, the configuration information may indicate that measurement procedures and/or measurement reports may be triggered by a message that includes a beam switch indication (e.g., a DCI message or a MAC-CE message).

In some aspects, the configuration information may indicate an action. For example, the configuration information may indicate that the one or more features are enabled for a P3 CSI-RS beam management (e.g., beam refinement for a receiver), a TRS, CSI measurement or reporting, or P2 CSI-RS beam management (e.g., beam refinement for a transmitter). As another example, the configuration information may indicate whether the action is periodic, aperiodic, or semi-persistent. For example, the configuration information may indicate whether a P3 or P2 CSI-RS beam management is performed periodically (e.g., using a configured resource associated with a periodicity), aperiodically (e.g., when triggered), or semi-persistently (e.g., using a configured resource that is activated or deactivated by dynamic signaling). As another example, the configuration information may indicate whether a TRS measurement is performed periodically (e.g., using a configured resource associated with a periodicity), aperiodically (e.g., when triggered), or semi-persistently (e.g., using a configured resource that is activated or deactivated by dynamic signaling).

In some aspects, the configuration information may indicate an association between a beam (or a TCI state) and a reference signal or a measurement report. For example, an association between an indicated TCI state for a beam switch, and a reference signal for measurement and/or a measurement report, may be configured by signaling from the base station 110 (such as RRC signaling (which can be updated via MAC signaling) or dynamic signaling such as DCI). In some aspects, the configuration information may be transmitted via RRC signaling or MAC signaling, and may associate a TCI state and trigger state, or a TCI state and a CSI-RS resource. If the configuration information is transmitted via MAC signaling, the UE 120 may apply the association after an activation period, which may be measured after transmitting an acknowledgment associated with the MAC signaling.

A beam may be associated with a TCI state. A TCI state may indicate a directionality or a characteristic of the beam, such as one or more quasi co-location (QCL) properties of the downlink beam. A QCL property may include, for example, a Doppler shift, a Doppler spread, an average delay, a delay spread, and/or spatial receive parameters, among other examples. A TCI state may be associated with one downlink reference signal set (e.g., an SSB and an aperiodic, periodic, or semi-persistent CSI-RS) for different QCL types (e.g., QCL types for different combinations of Doppler shift, Doppler spread, average delay, delay spread, or spatial receive parameters, among other examples).

In some aspects, the association may be between a TCI state and a CSI measurement without transmission of a measurement report. For example, a report quantity of a CSI report configuration of the CSI measurement may be set to “none”, which enables the UE 120 to perform a CSI measurement using the TCI state without transmitting a measurement report, thereby conserving signaling resources.

In some aspects, the association may be between a TCI state and a trigger state (such as a codepoint of a trigger state). In this case, the configuration information may be provided via a TCI configuration information element (IE), such as may be included in an RRC configuration of the TCI state. A TCI state (or beam) may be configured as associated with a trigger state (such as associated with a codepoint of the trigger state or a trigger state identifier of the trigger state). A trigger state may be associated with one or more CSI report configurations. For example, a trigger state may be associated with multiple CSI report configurations. Each CSI report configuration may include a report resource field, a CSI-RS resource configuration (including a CSI-RS resource list), and a report quantity. Thus, when the UE 120 receives an indication indicating a particular TCI state, the indication can also activate each CSI report configuration that is configured as associated with the particular TCI state. In some aspects, the configuration information may clarify which list the TCI state is associated with, from an SP-CSI report PUSCH list or an AP-CSI report list. Configuring the association between the TCI state and the trigger state may enable the reuse of a trigger state list parameter and a trigger state identifier, such that a TCI state can be associated with multiple CSI reporting configurations without defining a new information element or list.

In some aspects, the association may be between a TCI state and a CSI report configuration. In this case, the configuration information may be provided via an RC IE outside of the TCI state. If the association is between a TCI state and a CSI report configuration, the TCI state can be associated with any CSI report configuration identifier, such as an SP-CSI on a PUCCH.

In some aspects, the UE 120 may transmit an acknowledgment regarding the configuration information (not shown). The acknowledgment may indicate whether or not the configuration information was received. In some aspects, the UE 120 may apply the configuration information after an activation period. In some aspects, the activation period may be configured (such as via RRC configuration), may be indicated by the configuration information, or may be specified, such as in a wireless communication standard.

As shown by reference number 510, the UE 120 may configure the UE 120 for communicating with the base station 110. In some aspects, the UE 120 may configure the UE 120 based at least in part on the configuration information. In some aspects, the UE 120 may be configured to perform one or more operations described herein.

As shown by reference number 515, the base station 110 may transmit, and the UE 120 may receive, an indication to switch a beam used by the UE 120. For example, the base station 110 may transmit a DCI message or a MAC-CE message indicating an updated beam or an updated TCI state to be used by the UE 120. The UE 120 may switch to the beam indicated by the indication, and may optionally receive a downlink message (if the downlink message is scheduled by the DCI), as shown by reference number 520. Some examples are described herein in connection with the beam switch indication being included in a DCI message. However, the beam switch indication may be included in a MAC-CE message in a similar manner as described herein. The downlink message (e.g., the DCI message and/or the MAC-CE message) that indicates the beam switch may also trigger a beam measurement and a transmission of a measurement report. For example, as described elsewhere herein, the beam or TCI state may be associated with, or linked to, a trigger state and/or a CSI report configuration. Therefore, the UE 120 may identify that the trigger state and/or a CSI report configuration are to be activated based at least in part on receiving the indication to switch the beam used by the UE 120 (e.g., based at least in part on the beam or TCI state indicated by the beam switch indication). In some aspects, the indication (such as a MAC-CE) may activate multiple TCI states. In some aspects, a TCI state with a lowest identifier, of multiple activated TCI states, may be used for the association. In some other aspects, each of the multiple activated TCI states may trigger an RS or a measurement report. In some aspects, the UE 120 may transmit an acknowledgment regarding the beam switch indication (not shown). The acknowledgment may indicate whether or not the beam switch indication was received.

In some aspects, the beam switch indication may be included in DCI that uses a downlink DCI format. In some other aspects, the beam switch indication may be included in DCI that uses an uplink DCI format. In some aspects, the DCI that includes the beam switch indication may schedule another message (e.g., another downlink message or another uplink message).

As shown by reference number 525, the UE 120 may identify one or more RSs and/or one or more measurement reports based at least in part on the association provided in the configuration information. For example, the UE 120 may use the association, defined by the configuration information, to identify an RS (e.g., a configuration associated with an RS, a resource associated with an RS) and/or a measurement report (e.g., a configuration associated with a measurement report) corresponding to one or more TCI states identified by the indication.

As shown by reference number 530, the base station 110 may transmit, and the UE 120 may receive, one or more reference signals. For example, the reference signals may be signals to be measured by the UE 120 (e.g., as part of a beam measurement or a beam management procedure triggered by the beam switch indication). For example, the one or more reference signals may be CSI-RSs and/or TRSs, among other examples. The UE 120 may identify a timing of the transmission of a reference signal based at least in part on the configuration information (e.g., based at least in part on a CSI report configuration). In some aspects, the UE 120 may identify a timing of the transmission of a reference signal based at least in part on a timing of the DCI that includes the indication to switch the beam. For example, a timing offset for the reference signal may be relative to the timing of the DCI that includes the indication to switch the beam. In some aspects, the timing offset for the reference signal may be relative to a timing of ACK feedback associated with the DCI that includes the indication to switch the beam. In some aspects, a periodicity and/or a timing offset of a reference signal (such as a CSI-RS) and/or a corresponding measurement report (such as a CSI report) may be configured, such as via RRC signaling.

As shown by reference number 535, the UE 120 may measure the one or more reference signals. For example, the UE 120 may perform RSRP, RSRQ, and/or other Layer 1 measurements of the one or more reference signals. In some aspects, the UE 120 may perform the measurements based at least in part on a report configuration associated with the one or more reference signals. For example, the UE 120 may perform one or more measurements of a reference signal in accordance with a beam management procedure that is triggered by the beam switch indication.

As shown by reference number 540, the UE 120 may optionally transmit, and the base station 110 may receive, a measurement report indicating one or more measurements of the reference signal(s). For example, the UE 120 may transmit the measurement report if a configuration and/or a resource associated with the measurement report is associated with the TCI state of the beam switch indication. The UE 120 may use the configuration and/or the resource associated with the measurement report to transmit the measurement report. In some aspects, the UE 120 may not transmit a measurement report. For example, the UE 120 may be triggered to measure a reference signal without transmitting a measurement report, as described elsewhere herein. In this way, the base station 110 configures an association between a beam (e.g., a TCI state) and a corresponding RS (e.g., measurement) or measurement report, which enables triggering of the corresponding RS or measurement report using a beam switch indication identifying the TCI state.

In some aspects (not illustrated in FIG. 5), the indication to update the beam may trigger the UE 120 to transmit a reference signal such as an SRS. In some aspects, the base station 110 may signal configuration information indicating an association between an SRS resource or an SRS resource set and a TCI state. For example, the association can be based at least in part on an SRS resource set identifier or an aperiodic SRS trigger state codepoint (such as an index for a trigger state).

As indicated above, FIG. 5 is provided as an example. Other examples may differ from what is described with respect to FIG. 5.

FIG. 6 is a diagram illustrating an example 600 associated with a rule-based approach for a beam switch indication to trigger a reference signal for measurement or a measurement report, in accordance with the present disclosure. As shown in FIG. 6, a base station 110 and a UE 120 may communicate with one another in a wireless network, such as the wireless network 100. FIG. 6 depicts an example associated with a rule-based association between an indication to switch a beam and at least one of a reference signal for measurement or transmission of a measurement report (e.g., a CSI measurement report). For example, the indication may trigger the reference signal (or may trigger the UE 120 to measure the reference signal) or may trigger the UE 120 to transmit a measurement report regarding the measurement of the reference signal. The measurement report may be an aperiodic measurement report, a semi-persistent measurement report, and/or a periodic measurement report. In example 600, the association is based at least in part on a rule.

As shown by reference number 605, the base station 110 may transmit, and the UE 120 may receive, configuration information. In some aspects, the UE 120 may receive configuration information from another device (e.g., from another base station or another UE). In some aspects, the UE 120 may receive the configuration information via RRC signaling and/or MAC signaling (e.g., MAC-CEs). In some aspects, the configuration information may be updated by MAC signaling, or DCI. In some aspects, the configuration information may include an indication of one or more configuration parameters (e.g., already known to the UE 120) for selection by the UE 120 and/or explicit configuration information for the UE 120 to use to configure the UE 120. In some aspects, the configuration information may indicate a rule for determining an association between a beam (e.g., TCI state) and an RS or a measurement report, as described elsewhere herein. In some aspects, the configuration information may activate the rule.

In some aspects, the configuration information may indicate that one or more features are enabled for the UE 120 associated with measurement procedures and/or measurement reports that are triggered by beam switch indications. For example, the configuration information may indicate that measurement procedures and/or measurement reports may be triggered by a message that includes a beam switch indication (e.g., a DCI message or a MAC-CE message).

In some aspects, the configuration information may indicate an action. The action may be associated with the RS or the measurement report. The action may indicate a purpose of the RS or the measurement report. In some aspects, an action may indicate whether or not a measurement report should be transmitted. Examples of actions include P3 CSI-RS beam management (e.g., beam refinement for a receiver), measurement of a TRS, CSI measurement, and P2 CSI-RS beam management (e.g., beam refinement for a transmitter). As another example, the configuration information may indicate whether the action is periodic, aperiodic, or semi-persistent. For example, the configuration information may indicate whether a P3 or P2 CSI-RS beam management is performed periodically (e.g., using a configured resource associated with a periodicity), aperiodically (e.g., when triggered), or semi-persistently (e.g., using a configured resource that is activated or deactivated by dynamic signaling). As another example, the configuration information may indicate whether a TRS measurement is performed periodically (e.g., using a configured resource associated with a periodicity), aperiodically (e.g., when triggered), or semi-persistently (e.g., using a configured resource that is activated or deactivated by dynamic signaling).

In some aspects, the configuration information may use RRC signaling or MAC signaling to activate or deactivate a feature, or to select a type of a CSI report action (e.g., with a report, without a report, P2, P3, or SRS transmission). In some aspects, the configuration information may be applied after an activation period. For example, the activation period may be measured after transmitting an acknowledgment associated with MAC signaling of the configuration information.

As shown by reference number 610, the UE 120 may configure the UE 120 for communicating with the base station 110. In some aspects, the UE 120 may configure the UE 120 based at least in part on the configuration information. In some aspects, the UE 120 may be configured to perform one or more operations described herein.

As shown by reference number 615, the base station 110 may transmit, and the UE 120 may receive, an indication to switch a beam used by the UE 120. For example, the base station 110 may transmit a DCI message or a MAC-CE message indicating an updated beam or an updated TCI state to be used by the UE 120. The UE 120 may switch to the beam indicated by the indication, and may optionally receive a downlink message (if the downlink message is scheduled by the DCI), as shown by reference number 620. Some examples are described herein in connection with the beam switch indication being included in a DCI message. However, the beam switch indication may be included in a MAC-CE message in a similar manner as described herein. The downlink message (e.g., the DCI message and/or the MAC-CE message) that indicates the beam switch may also trigger a beam measurement and a transmission of a measurement report. For example, as described elsewhere herein, the beam or TCI state may be associated with, or linked to, a trigger state and/or a CSI report configuration based at least in part on a rule. Therefore, the UE 120 may identify that the trigger state and/or a CSI report configuration are to be activated based at least in part on receiving the indication to switch the beam used by the UE 120 (e.g., based at least in part on the beam or TCI state indicated by the beam switch indication). In some aspects, the indication (such as a MAC-CE) may activate multiple TCI states. In some aspects, a TCI state with a lowest identifier, of multiple activated TCI states, may be used for the association. In some other aspects, each of the multiple activated TCI states may trigger an RS or a measurement report. In some aspects, the UE 120 may transmit an acknowledgment regarding the beam switch indication (not shown). The acknowledgment may indicate whether or not the beam switch indication was received.

As shown by reference number 625, the UE 120 may identify at least one of a reference signal for measurement or a measurement report based at least in part on an association between the beam and the reference signal or the measurement report. In example 600, the association is defined by a rule. For example, the UE 120 may be preconfigured with the rule. As another example, the rule may be provided in the configuration information. As another example, the rule may be specified in a wireless communication standard, such as one promulgated by the 3GPP. As yet another example, the UE 120 may be hardcoded with the rule.

In some aspects, the rule indicates the RS or the measurement report based at least in part on a source RS of the beam. For example, the RS triggered by the indication may match an RS type of a source RS of a TCI state defining the beam. An RS type may include TRS, CSI-RS, or the like. In some aspects, the indication may trigger a periodic TRS (P-TRS). For example, the source RS of the TCI state may be a P-TRS. In some aspects, the indication may trigger an aperiodic TRS (AP-TRS). For example, the source RS of the TCI state may be a P-TRS associated with the AP-TRS (for example, associated by configuration or semi-static signaling) In some aspects, the indication may trigger a CSI-RS. For example, if a feature associated with a CSI report is activated, then a CSI-RS resource set that includes a source RS of the TCI state may be triggered. In this case, a CSI report configuration associated with a non-zero power (NZP) CSI-RS resource set list includes the triggered CSI-RS resource set may be activated. For example, the indication may trigger a measurement report associated with a measurement report configuration having an RS resource set to which the source RS belongs. An NZP CSI-RS resource is a CSI-RS resource configured for RS transmission (as opposed to a zero-power CSI-RS resource in which no RS may be transmitted). In some aspects, the NZP CSI-RS resource set list may contain a single CSI-RS resource set. In some aspects, the NZP CSI-RS resource set list may contain multiple CSI-RS resource sets, each including the triggered CSI-RS resource set. In some aspects, the NZP CSI-RS resource set list may contain multiple CSI-RS resource sets and all of the multiple CSI-RS resource sets may use the TCI state indicated by the indication.

In some aspects, the rule is based at least in part on an action associated with the measurement report or the RS (e.g., P2, P3, TRS). For example, if a feature associated with P3 CSI-RS beam management (e.g., beam refinement for a receiver) is activated, then a CSI-RS resource set with repetition activated, including a source RS of the indication, may be triggered. If a feature associated with P2 CSI-RS beam management is activated, then a CSI-RS resource set with repetition deactivated, including a source RS of the indication, may be triggered.

In some aspects, the rule indicates the reference signal or the measurement report based at least in part on a TCI state of the beam. For example, an RS resource may be configured as associated with the RS. If a TCI state has multiple source RSs for different QCL types, then the UE 120 may select a source RS of a particular QCL type to determine the RS triggered by the indication. For example, for an action associated with measuring a TRS, the UE 120 may select a source RS of the TCI state associated with QCL Type A (e.g., including Doppler shift, Doppler spread, average delay, and delay spread QCL parameters). For an action associated with P2 CSI-RS beam management or P3 CSI-RS beam management, the UE 120 may select a source RS of the TCI state associated with QCL Type D (e.g., including a spatial receive parameter QCL parameter).

For an action associated with measuring an AP-TRS, a TRS resource using the identified TCI state may be activated. For an action associated with measuring a CSI-RS and/or transmitting a CSI report, a CSI-RS resource set using the indicated TCI state may be triggered. In this case, a CSI report configuration whose NZP CSI-RS resource set list includes the triggered CSI-RS resource set may be activated. For example, the indication may trigger a measurement report associated with a measurement report configuration having an RS resource set to which the source RS belongs. In some aspects, the NZP CSI-RS resource set list must contain a single CSI-RS resource set. In some aspects, the NZP CSI-RS resource set list must contain multiple CSI-RS resource sets, each including the triggered CSI-RS resource set. In some aspects, the NZP CSI-RS resource set list may contain multiple CSI-RS resource sets and all of the multiple CSI-RS resource sets must use the TCI state indicated by the indication.

In some aspects, the rule is based at least in part on an action associated with the measurement report or the RS (e.g., P2 CSI-RS beam management, P3 CSI-RS beam management, TRS). For example, if a feature associated with P3 CSI-RS beam management (e.g., beam refinement for a receiver) is activated, then a CSI-RS resource set with repetition activated, and all CSI-RS resources using the indicated TCI state, may be triggered. If a feature associated with P2 CSI-RS beam management is activated, then a CSI-RS resource set with repetition deactivated, and all resources using the indicated TCI state, may be triggered. In this case, a beam management report configuration whose NZP CSI-RS set includes the triggered CSI-RS resource set may be activated. In some aspects, the NZP CSI-RS resource set list must contain only the triggered CSI-RS resource set. In some aspects, the NZP CSI-RS resource set list must contain multiple CSI-RS resource sets the triggered CSI-RS resource set. In some aspects, the NZP CSI-RS resource set list may contain multiple CSI-RS resource sets and all of the multiple CSI-RS resource sets must use the TCI state indicated by the indication.

In some aspects, the association between a TCI state and a resource set may be unique (e.g., a TCI state may be configured as associated with a single resource set, or the rule may indicate that a TCI state is associated with a single resource set). In some other aspects, the association between a TCI state and a resource set may be based at least in part on a prioritization rule. For example, the UE 120 may select among multiple candidate resource sets, such as based at least in part on a lowest resource set identifier of the multiple candidate resource sets.

In some aspects, the triggered reference signal is a pre-defined CSI-RS resource set list with floating TCI state. For example, a CSI-RS resource set list may be defined that includes one or more CSI-RS resource sets that are configured to be triggered by the beam switch indication. Each CSI-RS resource set may define one or more reference signal resources. The TCI state is referred to as a floating TCI state because the CSI-RS resource set has an undefined TCI state. After receiving the indication, the indicated TCI state may be applied to the CSI-RS resource set list, and RSs on CSI-RS resources of the CSI-RS resource set list may be triggered. The CSI-RS resource set list can include a TRS resource, a CSI-RS resource set with repetition activated, or a CSI-RS resource set with activation deactivated. In some aspects, each CSI-RS resource or resource set of the list may be associated with a respective action (e.g., P2 CSI-RS beam management, P3 CSI-RS beam management, TRS, etc.). Each CSI-RS resource set may be associated with a respective report quantity corresponding to the respective action. In some aspects, a reporting configuration for the measurement report, associated with the CSI-RS resource set list, may be activated by the indication to switch the beam.

In some aspects, each CSI-RS resource set with a floating TCI state, as described above, may be further associated with a reporting configuration. The association between a CSI-RS resource set and a reporting configuration can be configured by signaling or by a rule. In some aspects, a report quantity of the reporting configuration may be configured as undefined. For example, the reporting configuration may have a floating quantity, meaning that the report quantity may be derived from the rule or the configured association. In this case, the rule may indicate the report quantity based at least in part on an action associated with the measurement report. “Reporting configuration” is used interchangeably with “report configuration” herein.

In some aspects, each CSI-RS resource set of the pre-defined CSI-RS resource set list may be associated with a reporting configuration, and each CSI-RS resource set may be associated with an action (e.g., one CSI-RS resource set for P2 CSI-RS beam management, one CSI-RS resource set for P3 CSI-RS beam management, and so on). In this case, the CSI-RS resource sets of the CSI-RS resource set list may have a floating TCI state, as described above. This may reduce the number of configured CSI-RS resource sets from the number of configured TCI states to the number of action types. In this case, the UE 120 may receive signaling (such as dynamic signaling or RRC down-selection) indicating which CSI-RS resource set and reporting configuration is to be used.

In some aspects (not illustrated in FIG. 6), the indication to update the beam may trigger the UE 120 to transmit a reference signal such as an SRS. In some aspects, the UE 120 may have (e.g., be pre-configured with, be hardcoded with) information indicating a rule defining an association between an SRS resource or an SRS resource set and a TCI state. As one example, the rule may indicate that the triggered SRS is identified based at least in part on a source RS of the indicated TCI state of the indication to switch the beam. As another example, the rule may indicate that the triggered SRS is identified based at least in part on the indicated TCI state of the indication to switch the beam. As yet another example, the rule may indicate that the triggered SRS is identified based at least in part on an SRS resource set with a floating TCI state (or floating spatial relation information, such as a floating SRS resource indicator).

As shown by reference number 630, the base station 110 may transmit, and the UE 120 may receive, one or more reference signals. For example, the reference signals may be signals to be measured by the UE 120 (e.g., as part of a beam measurement or a beam management procedure triggered by the beam switch indication). For example, the one or more reference signals may be CSI-RSs and/or TRSs, among other examples. The UE 120 may identify a timing of the transmission of a reference signal based at least in part on the configuration information (e.g., based at least in part on a CSI report configuration). In some aspects, the UE 120 may identify a timing of the transmission of a reference signal based at least in part on a timing of the DCI that includes the indication to switch the beam. For example, a timing offset for the reference signal may be relative to the timing of the DCI that includes the indication to switch the beam. In some aspects, the timing offset for the reference signal may be relative to a timing of ACK feedback associated with the DCI that includes the indication to switch the beam. In some aspects, a periodicity and/or a timing offset of a reference signal (such as a CSI-RS) and/or a corresponding measurement report (such as a CSI report) may be configured, such as via RRC signaling.

As shown by reference number 635, the UE 120 may measure the one or more reference signals. For example, the UE 120 may perform RSRP, RSRQ, and/or other Layer 1 measurements of the one or more reference signals. In some aspects, the UE 120 may perform the measurements based at least in part on a report configuration associated with the one or more reference signals. For example, the UE 120 may perform one or more measurements of a reference signal in accordance with a beam management procedure that is triggered by the beam switch indication.

As shown by reference number 640, the UE 120 may optionally transmit, and the base station 110 may receive, a measurement report indicating one or more measurements of the reference signal(s). For example, the UE 120 may transmit the measurement report if a configuration and/or a resource associated with the measurement report is associated with the TCI state of the beam switch indication. The UE 120 may use the configuration and/or the resource associated with the measurement report to transmit the measurement report. In some aspects, the UE 120 may not transmit a measurement report. For example, the UE 120 may be triggered to measure a reference signal without transmitting a measurement report, as described elsewhere herein. In this way, the UE 120 identifies an association between a beam (e.g., a TCI state) and a corresponding RS (e.g., measurement) or measurement report using a rule, which enables triggering of the corresponding RS or measurement report using a beam switch indication identifying the TCI state while reducing overhead associated with configuring the association between the beam and the corresponding RS or measurement report.

In some aspects, the UE 120 may use the rule-based approach to determine an association if signaling indicating an association is not received. For example, if the feature of triggering a measurement or measurement report with a beam switch indication is activated by a RRC flag, and the RRC information element to define an association between a TCI state and a measurement or measurement report is not configured, then the UE 120 may use a rule as described in connection with FIG. 6 to identify measurement or measurement report triggered by the TCI state.

As indicated above, FIG. 6 is provided as an example. Other examples may differ from what is described with regard to FIG. 6.

In some aspects, a UE may be configured to monitor a measurement, such as an RSRP, of one or more reference signals. Based at least in part on one or more measurements of the one or more reference signals meeting one or more pre-defined conditions, the UE may declare a pre-determined (e.g., specific) type of beam failure recovery (BFR) and may send a BFR request to a base station. The types of BFR can include a per TRP BFR, a secondary cell BFR, or a special cell BFR. In the BFR request, UE may indicate, to the base station, a new beam to replace the failed beams. The base station may send an indication to the UE of whether the UE can automatically reset the reported beam as a communication beam, after a BFR procedure is successfully finished. If the base station configures the UE to apply the automatic beam reset, the UE may automatically reset the communicating beam to the reported beam in the request upon receiving a response from the base station for the BFR request.

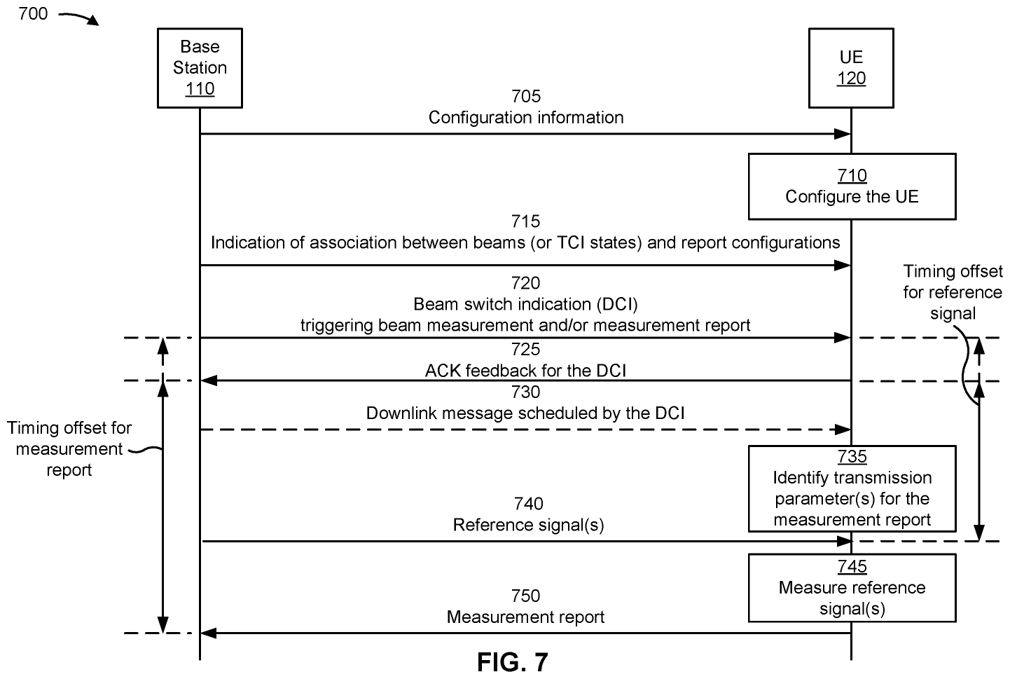

FIG. 7 is a diagram illustrating an example 700 associated with a measurement report triggered by a beam switch indication, in accordance with the present disclosure. As shown in FIG. 7, a base station 110 and a UE 120 may communicate with one another in a wireless network, such as the wireless network 100. FIG. 7 depicts an example associated with configuring timing and other transmission parameters for a measurement report (e.g., a CSI measurement report) that is triggered by a beam switch indication. The measurement report may be an aperiodic measurement report, a semi-persistent measurement report, and/or a periodic measurement report. The measurement report may be associated with an uplink control channel (e.g., the measurement report may be configured to be transmitted on the PUCCH). In some other aspects, the measurement report may be associated with an uplink shared channel (e.g., the measurement report may be configured to be transmitted on the PUSCH).

As shown by reference number 705, the base station 110 may transmit, and the UE 120 may receive, configuration information. In some aspects, the UE 120 may receive configuration information from another device (e.g., from another base station or another UE). In some aspects, the UE 120 may receive the configuration information via RRC signaling and/or MAC signaling (e.g., MAC-CEs). In some aspects, the configuration information may include an indication of one or more configuration parameters (e.g., already known to the UE 120) for selection by the UE 120 and/or explicit configuration information for the UE 120 to use to configure the UE 120.

In some aspects, the configuration information may indicate that one or more features are enabled for the UE 120 associated with beam measurement procedures and/or measurement reports that are triggered by beam switch indications. For example, the configuration information may indicate that beam measurement procedures and/or measurement reports may be triggered by a message that includes a beam switch indication (e.g., a DCI message or a MAC-CE message).

In some aspects, the configuration information may indicate one or more measurement reporting configurations (e.g., CSI reporting configurations). For example, the configuration information may indicate one or more trigger states. Each trigger state may be associated with one or more CSI report configurations. Each CSI report configuration may indicate a channel associated with the CSI report configuration (e.g., the PUCCH or the PUSCH), a reporting resource (e.g., a resource to be used to transmit the measurement report), a reference signal resource configuration (e.g., a CSI resource list), a report quantity (e.g., indicating whether a measurement report is to be transmitted after measurement the reference signal indicated by the reference signal resource configuration), and/or scheduling type associated with the CSI report configuration (e.g., aperiodic, semi-persistent, or periodic), among other examples. In some aspects, a CSI report configuration may indicate one or more transmission parameters to be used for transmitting the measurement report. For example, a downlink message (e.g., a DCI message or a MAC-CE message) triggering or activating a CSI report configuration may indicate a trigger state (e.g., by indicating a trigger state identifier or codepoint in the downlink message). All CSI report configurations associated with the trigger state may be activated, at the UE 120, based at least in part on the downlink message indicating the trigger state.

For a measurement report to be transmitted using the uplink control channel (e.g., the PUCCH), the configuration information may indicate information (e.g., a CSI report configuration) for measurement reports to be transmitted using the uplink control channel. The CSI report configuration may indicate the TDRA, the FDRA, and/or the MCS, among other examples, to be used by the UE 120 to transmit the measurement report. For a measurement report to be transmitted using the uplink control channel, a timing of the measurement report may be indicated by an offset value that indicates an amount of time relative to a time at which the reporting configuration takes effect. For example, for a measurement report to be transmitted using the uplink control channel, the associated CSI report configuration may be activated by a MAC-CE message. Some time (e.g., a number of slots defined by the configuration information or by a wireless communication standard) after the UE transmits ACK feedback associated with the MAC-CE message, the CSI report configuration may take effect. The timing of the reference signal transmission by the base station 110 (e.g., the CSI-RS transmission) and the timing of the measurement report transmission by the UE 120 may be defined relative to the time at which the CSI report configuration may takes effect.

For a measurement report to be transmitted using the uplink shared channel (e.g., the PUSCH), the CSI report configuration may indicate a timing offset associated with the reference signal (e.g., with the CSI-RS). However, one or more transmission parameters for the measurement report may be indicated by the message that triggers the beam measurement and/or the measurement report. For example, a TDRA, an FDRA, and/or an MCS to be used to transmit the measurement report may be indicated by a downlink message that triggers or activates the CSI report configuration associated with the measurement report. For example, a downlink message may indicate a timing offset value associated with the measurement report that indicates an amount of time from a transmission of the downlink message (e.g., that triggers or activates the CSI report configuration) by the base station 110 to a transmission of the measurement report by the UE 120. The timing offset value may be indicated by identifying an entry in a TDRA table configured by the configuration information (e.g., the downlink message may identify the entry in the TDRA table and the UE 120 may perform a lookup operation to identify the timing offset value from a configured TDRA table). Additionally, the downlink message (e.g., that triggers or activates the CSI report configuration) may indicate an FDRA and/or an MCS, among other examples, to be used by the UE 120 to transmit the measurement report. The configuration information may indicate that some transmission parameters for the measurement report (e.g., that are not indicated by the configuration information) may be indicated by the downlink message that triggers or activates the CSI report configuration (e.g., that triggers the beam measurement and/or the measurement report).

In some aspects, the configuration information may indicate an association between a beam (or a TCI state) and a CSI report configuration. A beam may be associated with a TCI state. A TCI state may indicate a directionality or a characteristic of the beam, such as one or more QCL properties of the downlink beam. A QCL property may include, for example, a Doppler shift, a Doppler spread, an average delay, a delay spread, and/or spatial receive parameters, among other examples. A TCI state may be associated with one downlink reference signal set (e.g., an SSB and an aperiodic, periodic, or semi-persistent CSI-RS) for different QCL types (e.g., QCL types for different combinations of Doppler shift, Doppler spread, average delay, delay spread, or spatial receive parameters, among other examples). The configuration information may associate different beams or different TCI states with different CSI report configurations. In some aspects, a TCI state (or beam) may be associated with a CSI report configuration. In some other aspects, a TCI state (or beam) may be associated with a trigger state (e.g., that is associated with one or more CSI report configurations). In this way, when a downlink message associated with a beam switch indication includes an indication of a beam or a TCI state, an associated CSI report configuration or trigger state may also be indicated in the same downlink message (e.g., without including additional information in the downlink message). For example, a CSI report configuration may be linked to a TCI state, thereby enabling the CSI report configuration to be indicated when a beam switch or beam update indicates the TCI state. The association between TCI states may be based at least in part on an explicit indication in the configuration and/or may be based at least in part on one or more rules (e.g., defined by the configuration information and/or defined by a wireless communication standard).

As shown by reference number 710, the UE 120 may configure the UE 120 for communicating with the base station 110. In some aspects, the UE 120 may configure the UE 120 based at least in part on the configuration information. In some aspects, the UE 120 may be configured to perform one or more operations described herein.

In some aspects, the UE 120 may transmit, and the base station 110 may receive, an indication of a capability of the UE 120 to support triggering beam measurements and/or measurement reports by a beam switch indication. For example, the UE 120 may transmit capability information indicating whether the UE 120 supports beam measurements and/or measurement reports that are triggered by a beam switch indication (e.g., without an explicit or separate message to trigger the beam measurements and/or the measurement reports). In some aspects, the UE 120 may transmit an indication of a processing capability of the UE 120. For example, the UE 120 may transmit an indication of a CSI processing capability (e.g., indicating an amount of time needed by the UE 120 to compute CSI measurements after receiving a reference signal, such as a CSI-RS). In some aspects, the UE 120 may transmit an indication of an ACK/NACK processing capability (e.g., indicating an amount of time needed by the UE 120 to process and/or decode a signal to determine if the signal was received successfully). In some aspects, the UE 120 may transmit the indication of the capability via RRC signaling, one or more MAC-CEs, and/or a PUCCH message, among other examples. In some aspects, the base station 110 may determine the configuration information based at least in part on the indication of the capability transmitted by the UE 120.

As shown by reference number 715, the base station 110 may transmit, and the UE 120 may receive, an indication of an association between beams (or TCI states) and CSI reporting configurations. For example, as described elsewhere herein, the base station 110 may configure an association, or a linkage, between TCI states and CSI report configurations to enable a beam switch indication (e.g., that indicates a TCI state) to trigger or activate a CSI report configuration (e.g., that is associated with, or linked to, the TCI state indicated by the beam switch indication. As described elsewhere herein, the association between beams (or TCI states) and CSI reporting configurations may be included in the configuration information (e.g., in an RRC configuration). In some aspects, the indication of the association between beams (or TCI states) and CSI reporting configurations may be transmitted by the base station 110 in another downlink message, such as a MAC-CE or an RRC reconfiguration message. In some aspects, a beam management procedure (e.g., one or more of the beam management procedures described in connection with FIG. 4 or another beam management procedure) may be indicated by the beam switch indication and/or may be linked to the beam or TCI state indicated by the beam switch indication.

As shown by reference number 720, the base station 110 may transmit, and the UE 120 may receive, an indication to switch a beam used by the UE 120. For example, the base station 110 may transmit a DCI message or a MAC-CE message indicating an updated beam or an updated TCI state to be used by the UE 120. Some examples are described herein in connection with the beam switch indication being included in a DCI message. However, the beam switch indication may be included in a MAC-CE message in a similar manner as described herein. The downlink message (e.g., the DCI message and/or the MAC-CE message) that indicates the beam switch may also trigger a beam measurement and a transmission of a measurement report. For example, as described elsewhere herein, the beam or TCI state may be associated with, or linked to, a trigger state and/or a CSI report configuration. Therefore, the UE 120 may identify that the trigger state and/or a CSI report configuration are to be activated based at least in part on receiving the indication to switch the beam used by the UE 120 (e.g., based at least in part on the beam or TCI state indicated by the beam switch indication).

In some aspects, the beam switch indication may be included in DCI that uses a downlink DCI format. In some other aspects, the beam switch indication may be included in DCI that uses an uplink DCI format. In some aspects, the DCI that includes the beam switch indication may schedule another message (e.g., another downlink message or another uplink message).

As shown by reference number 725, the UE 120 may transmit, and the base station 110 may receive ACK feedback associated with the DCI (e.g., associated with the message that includes the beam switch indication). For example, the UE 120 may process and/or decode the DCI message. The UE 120 may determine that the DCI message has been successfully received by the UE 120 (e.g., based at least in part on processing and/or decoding the DCI message). Therefore, the UE 120 may transmit ACK feedback to the base station 110 to indicate that the DCI message was successfully received by the UE 120.

In some aspects, as shown by reference number 730, the base station 110 may transmit, and the UE 120 may receive, a downlink message that is scheduled by the DCI (e.g., the DCI that indicates the beam switch indication). For example, if the DCI that indicates the beam switch indication scheduled another downlink message, the base station 110 may transmit, and the UE 120 may receive, the downlink message. In some aspects, the downlink message may include information associated with transmitting a measurement report, as explained in more detail elsewhere herein. For example, the downlink message may include an indication of one or more transmission parameters to be used by the UE 120 to transmit a CSI measurement report (e.g., that is triggered by the DCI that indicates the beam switch indication).

As shown by reference number 735, the UE 120 may identify one or more transmission parameters for the measurement report that is triggered by the beam switch indication. For example, the UE 120 may identify a TDRA, an FDRA, and/or an MCS, among other examples, to be used by the UE 120 to transmit the measurement report (e.g., the CSI measurement report). In some aspects, the UE 120 may identify the one or more transmission parameters based at least in part on the configuration information. Additionally, or alternatively, the UE 120 may identify the one or more transmission parameters based at least in part on the downlink message (e.g., the DCI or the MAC-CE) that includes the beam switch indication. In some aspects, the UE 120 may identify the one or more transmission parameters based at least in part on another downlink message (e.g., a downlink message scheduled by DCI that includes the beam switch indication). Therefore, the UE 120 may identify time domain resources, frequency domain resources, and/or other transmission parameters to be used to transmit a measurement report that is triggered by a beam switch indication.

In some aspects, such as where no measurement report is to be transmitted (e.g., where the UE 120 is configured or triggered to only measure a reference signal, such as a CSI-RS, but not transmit a measurement report) or where the measurement report is to be transmitted using an uplink control channel (e.g., the PUCCH), the configuration information may indicate one or more timing offset values associated with the transmission of the reference signal and/or the transmission of the measurement report. However, as described elsewhere herein, these timing offset values may be defined with respect to a time at which a CSI report configuration is to take effect (e.g., as indicated by a MAC-CE message). However, when the beam measurement and/or measurement report is triggered by a beam switch indication, there may be no MAC-CE message transmitted by the base station 110, such as when the beam switch indication is included in DCI. As a result, it may be unclear as to a reference point for the timing offset values indicated by the configuration information.

Therefore, in some aspects, a timing offset value (e.g., associated with a transmission of the reference signal and/or the transmission of the measurement report) may indicate an amount of time relative to transmitting (by the UE 120) the acknowledgment feedback (e.g., the ACK feedback) associated with the DCI that includes the beam switch indication. For example, the configuration information may indicate a value for the timing offset for the reference signal and/or the timing offset of the measurement report (e.g., as shown in FIG. 7) and the values may be relative to the ACK feedback transmitted by the UE 120 (e.g., shown by reference number 725). In some other aspects, a timing offset value (e.g., associated with a transmission of the reference signal and/or the transmission of the measurement report) may indicate an amount of time relative to receiving (by the UE 120) the indication to switch the beam (e.g., the DCI indicated by reference number 720). For example, the configuration information may indicate a value for the timing offset for the reference signal and/or the timing offset of the measurement report (e.g., as shown in FIG. 7) and the values may be relative to the DCI that includes the beam switch indication (e.g., shown by reference number 720). Other transmission parameters for the reference signal and/or the measurement report may be indicated by the configuration information (e.g., for the case in which no measurement report is to be transmitted or where the measurement report is to be transmitted using an uplink control channel, such as for a semi-persistent measurement report transmitted on the PUCCH). Therefore, the UE 120 may be enabled to identify a TDRA for the reference signal and/or the measurement report based at least in part on identifying the timing offset value(s) and/or on identifying the reference point (e.g., the ACK feedback and/or the DCI including the beam switch indication) for the timing offset value(s).

In some aspects, such as where the measurement report is to be transmitted on an uplink shared channel (e.g., the PUCCH), the configuration information may not indicate some transmission parameters for the measurement report, such as a TDRA, an FDRA, and/or an MCS, among other examples. For example, the configuration information may configure one or more TDRA tables. The TDRA tables may be PDSCH TDRA tables (for downlink communications) or PUSCH TDRA tables (e.g., for uplink communications). For example, DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The base station 110 and the UE 120 may use those TDRA parameters for the scheduled communications. For an uplink communication (e.g., a PUSCH communication), the TDRA parameters may include, for example, a K2 value, an S value, and an L value. As described elsewhere herein, the K2 value may represent a scheduling offset or a timing offset (e.g., in number of slots) between the slot containing the scheduling DCI (that schedules the PUSCH communication) and the slot containing the scheduled PUSCH communication (scheduled by the scheduling DCI). The S value may represent a starting symbol for the PUSCH communication in the indicated slot. The L value may represent a length (e.g., a number of consecutive symbols) of the PUSCH communication (e.g., in the indicated slot). For example, when a measurement report is to be transmitted on the PUSCH, a DCI (e.g., an uplink DCI) may indicate a TDRA index value associated with the measurement report. The UE 120 may identify the TDRA for the measurement report based at least in part on TDRA parameters in a TDRA table indicated by the TDRA index value.

However, as described above, in some cases, the DCI that includes the beam switch indication may use a downlink DCI format. The downlink DCI format may not include a field for indicating a TDRA index value of a PUSCH TDRA table (and/or fields for indicating other transmission parameters for a PUSCH transmission). Therefore, in some cases, when a measurement report is triggered by a beam switch indication, the measurement report may only be a PUCCH measurement report (e.g., may only be a measurement report transmitted on the PUCCH). This may enable the UE 120 to identify the transmission parameters for the measurement report from the configuration information and/or the reference points for timing offset values, as described above. In other words, measurement reports transmitted on an uplink shared channel (e.g., the PUSCH) may not be supported by the UE 120 and the base station 110 when the measurement reports are triggered by beam switch indications. For example, the UE 120 may transmit, and the base station 110 may receive, the measurement report on an uplink control channel based at least in part on the measurement report being triggered by the indication to switch the beam. This may reduce a complexity associated with identifying the transmission parameters associated with the measurement report that is triggered by the beam switch indication.

In some aspects, the DCI that includes the beam switch indication may use an uplink DCI format. Therefore, the DCI may include fields for indicating a TDRA (e.g., a TDRA index value), an FDRA, and/or an MCS, among other examples, for a PUSCH transmission. As a result, the DCI that includes the beam switch indication may also indicate the one or more transmission parameters for the measurement report to be transmitted on the PUSCH. For example, the base station 110 may transmit, and the UE 120 may receive, DCI including the indication to switch the beam (as shown by reference number 720), where the DCI uses an uplink DCI format, and where the DCI indicates the one or more transmission parameters for the measurement report to be transmitted on the PUSCH. Therefore, for an aperiodic or a semi-persistent measurement report (e.g., CSI measurement report) to be transmitted on the PUSCH, the DCI that includes the beam switch indication may also indicate transmission parameters associated with the measurement report. This may reduce a complexity associated with identifying the transmission parameters associated with the measurement report and reduce a signaling overhead associated with triggering the beam switch indication and the measurement report.

In some aspects, such as where the DCI that includes the beam switch indication uses a downlink DCI format and where the measurement report is to be transmitted on an uplink shared channel (e.g., the PUCCH), the base station 110 may transmit, and the UE 120 may receive, a message indicating the one or more transmission parameters to be used for transmitting the measurement report. In other words, the base station 110 may explicitly signal the one or more transmission parameters to be used for transmitting the measurement report when the DCI that includes the beam switch indication uses a downlink DCI format and where the measurement report is to be transmitted on an uplink shared channel. For example, in some cases, the message may be the message that includes the configuration information. For example, the message may be an RRC message. The RRC message may indicate transmission parameters that are to be used to transmit the measurement report. For example, the base station 110 may transmit an indication of transmission parameters to be used by the UE 120 to transmit the measurement report in the same message as the indication of the association between beams (or TCI states) and CSI report configurations (shown by reference number 715). For example, a list of transmission parameters (for measurement reports triggered by beam switch indications) may be configured in an RRC configuration. The base station 110 may select a set of transmission parameters (e.g., from the RRC configured transmission parameters), for the UE 120 to use to transmit measurement reports triggered by beam switch indications, via another downlink message, such as a MAC-CE message or a DCI message. In other words, an RRC configuration may configure a list of transmission parameters and the base station 110 may select one or more transmission parameters (from the RRC configured list of transmission parameters) via MAC-CE signaling or DCI signaling. The MAC-CE signaling or the DCI signaling may be the same message that indicates the beam switch indication or may be a different message.

For example, the configuration information (e.g., RRC configuration information) may indicate one or more sets of transmission parameters for measurement reports triggered by beam switch indications. The DCI that includes the indication to switch the beam may further indicate a set of transmission parameters, from the one or more sets of RRC configured transmission parameters, to be used for the measurement report.

As another example, the configuration information (e.g., RRC configuration information) may indicate one or more TDRA tables. In some aspects, a TDRA table, of the one or more TDRA tables, includes entries having downlink values and uplink values. For example, for a row or an entry in the TDRA table, the TDRA table may indicate multiple values for each parameter associated with the TDRA table (e.g., may indicate 2 values for the K2 value, 2 values for an S parameter, and so on). For example, a downlink value for a parameter may be used for a downlink transmission (e.g., a PDSCH transmission) scheduled by DCI and an uplink value for a parameter may be used for an uplink transmission (e.g., a PUSCH transmission) scheduled by DCI, such as the measurement report. Therefore, the DCI (e.g., that includes the indication to switch the beam) may indicate a single TDRA index value. The single TDRA index value may enable the UE 120 to identify multiple TDRAs (e.g., a first TDRA for a downlink message scheduled by the DCI and a second TDRA for the measurement report triggered by the DCI) from a single TDRA table. For example, the base station 110 may transmit, and the UE 120 may receive, an indication of an entry of the TDRA table (e.g., a TDRA table index value in DCI). The entry may include one or more downlink values and one or more uplink values. The UE 120 may identify a TDRA for the measurement report based at least in part on the one or more uplink values (e.g., one or more transmission parameters to be used to transmit the measurement report may be indicated by the one or more uplink values in the TDRA table). The DCI (e.g., that includes the indication to switch the beam and that triggers the transmission of the measurement report) may include scheduling grant for a downlink message (e.g., the scheduling grant may be included in a same message (e.g., the DCI message) as the indication to switch the beam). A TDRA for the downlink message may be indicated by the one or more downlink values in the entry of the TDRA table. In this way, a single DCI message may convey transmission parameters (e.g., a TDRA) for downlink messages and uplink messages scheduled or triggered by the DCI.

In some aspects, the DCI (e.g., that includes the indication to switch the beam) may indicate multiple TDRA index values (e.g., one or more TDRA index values for downlink messages scheduled by the DCI and one or more TDRA index values for uplink messages scheduled by the DCI). For example, the base station 110 may transmit, and the UE 120 may receive, a first indication of a first entry of a first TDRA table, of the one or more RRC configured TDRA tables, and a second indication of a second entry of a second TDRA table of the one or more RRC configured TDRA tables. The first entry may indicate one or more transmission parameters for a downlink message scheduled by the DCI (e.g., the downlink message shown by reference number 730). The second entry may indicate the one or more transmission parameters (e.g., the TDRA and/or a timing offset value, such as a K2 value) for the measurement report. In some aspects, the first entry and the second entry may be associated with the same TDRA table or different TDRA tables. In this way, a single DCI message may convey transmission parameters (e.g., a TDRA) for downlink messages and uplink messages scheduled or triggered by the DCI. Therefore, a DCI that indicates a beam switch (e.g., using a downlink DCI format) may also indicate a TDRA (and/or one or more other transmission parameters, such a timing offset or a scheduling offset) for a measurement report triggered by the DCI.

In some aspects, the message (e.g., that indicates the one or more transmission parameters) may be a MAC-CE message. For example, the base station 110 may transmit, and the UE 120 may receive, a MAC-CE message that indicates one or more transmission parameters to be used by the UE 120 to transmit a measurement report (e.g., on the PUSCH) when the measurement report is triggered by a beam switch indication. In some aspects, the MAC-CE message may indicate a list of transmission parameters and the base station 110 may select one or more transmission parameters (from the list of transmission parameters) via DCI signaling.

In some aspects, the message (e.g., that indicates the one or more transmission parameters) may be the DCI message that includes the indication to switch the beam. For example, the base station 110 may transmit, and the UE 120 may receive, an indication of the one or more transmission parameters in the same downlink message as the indication to switch the beam. For example, the DCI that includes the indication to switch the beam may also include an indication of the one or more transmission parameters to be used by the UE 120 to transmit the measurement report on the PUSCH. In some aspects, the DCI may use a downlink DCI format and may schedule another downlink message (e.g., the downlink message shown by reference number 730). The DCI may include one or more additional fields to indicate the one or more transmission parameters (e.g., a TDRA, a TDRA table index value, an FDRA, and/or an MCS, among other examples) to be used by the UE 120 to transmit the measurement report on the PUSCH. In some aspects, the DCI may use a downlink DCI format and may not schedule another downlink message. In such examples, the base station 110 may use one or more fields that would have otherwise been used to schedule a downlink message (e.g., in the DCI) to indicate the one or more transmission parameters (e.g., a TDRA, a TDRA table index value, an FDRA, and/or an MCS, among other examples) to be used by the UE 120 to transmit the measurement report on the PUSCH.

In some aspects, the UE 120 may identify a transmission parameter to be used to transmit the measurement report on the PUSCH based at least in part on a rule. The rule may be defined by the base station 110 (e.g., in the configuration information) or may be defined by a wireless communication standard, such as the 3GPP. For example, a rule may indicate a given transmission parameter that is to be used when a measurement report (e.g., a CSI measurement report) is triggered by a beam switch indication. For example, a rule may indicate a given MCS to be used for a measurement report (e.g., a CSI measurement report) that is triggered by a beam switch indication. As another example, a rule may indicate a timing offset value (e.g., a K2 value), from a list of RRC configured timing offset values, that is to be used for a measurement report (e.g., a CSI measurement report) that is triggered by a beam switch indication. Using rule based transmission parameter identification may reduce complexity and a signaling overhead associated with the UE 120 identify the transmission parameters to be used by the UE 120 to transmit the measurement report.

In some aspects, one or more transmission parameters to be used by the UE 120 to transmit the measurement report may be signaled to the UE 120 by the base station 110 (e.g., via RRC signaling, DCI signaling, and/or MAC-CE signaling), as described above, and one or more transmission parameters to be used by the UE 120 to transmit the measurement report may be identified by the UE 120 based at least in part on a rule, as described above. In other words, the UE 120 may identify the transmission parameters to be used to transmit the measurement report using a combination of signaling and rule based identification to identify the transmission parameters to be used to transmit the measurement report on the PUSCH. For example, an MCS associated with the measurement report may be identified by the UE 120 using a rule and a TDRA and an FDRA to be used to transmit the measurement report on the PUSCH may be signaled (by the base station 110) to the UE 120.

In some aspects, an aperiodic measurement report (e.g., an aperiodic CSI measurement report) may be enabled to be transmitted on an uplink control channel (e.g., the PUCCH). For example, typically only semi-persistent or periodic measurement reports are transmitted on the PUCCH because aperiodic messages may be dynamic and may PUCCH resources may be not configured to handle the dynamic messages. For example, the configuration information (e.g., RRC configuration information) may indicate a PUCCH resource configuration and/or one or more timing offset values. A DCI that schedules a control channel message may indicate a timing offset value indicating an amount of time from the scheduled message to a reporting time for feedback (e.g., ACK/NACK feedback) associated with the scheduled message. This timing offset value may sometimes be referred to as a “Kl” value. For example, the configuration information may indicate a set of K1 values and the DCI may indicate (e.g., using an index value) a K1 value to be used by the UE 120 from the set of K1 values. In some aspects, the DCI (e.g., that includes the indication to switch the beam) may include an indication of a timing offset value associated with the aperiodic measurement report, where the timing offset value indicates an amount of time from receiving the indication to switch the beam (e.g., from receiving the DCI) to transmitting the aperiodic measurement report on the PUCCH (e.g., a K2 value). For example, the base station 110 may transmit, and the UE 120 may receive, an indication of the timing offset value in the DCI that includes the indication to switch the beam.

In some aspects, a first timing offset value associated with the measurement report (e.g., the K2 value) may be based at least in part on a second timing offset value associated with the ACK/NACK feedback (e.g., the K1 value). For example, the DCI (e.g., that includes the indication to switch the beam) may schedule a downlink message and may indicate the second timing offset value (e.g., a K1 value) associated with transmitting feedback for the downlink message scheduled by the DCI. The configuration information may indicate an associated between K1 values and K2 values. For example, the configuration information (e.g., RRC configuration information) may indicate associations between timing offset values associated with transmitting feedback for downlink messages (e.g., K1 values) and timing offset values associated with transmitting measurement reports triggered by beam switch indications (e.g., K2 values). The UE 120 may identify the K2 value associated with the measurement report based at least in part on the K1 value indicated by the DCI and based at least in part on the associations indicated by the configuration information.

In some aspects, to transmit the aperiodic measurement report on the PUCCH, the aperiodic measurement report may be multiplexed (e.g., merged or combined) with ACK/NACK feedback for a downlink message scheduled by the DCI (e.g., the DCI that includes the indication to switch the beam). For example, the DCI that includes the indication to switch the beam may also schedule a downlink message (e.g., a PDSCH message), such as the downlink message shown by reference number 730. The DCI may indicate a timing offset value (e.g., a K1 value) that indicates an amount of time between the reception of the downlink message (e.g., at the UE 120) and a transmission of a feedback message associated with the downlink message. Therefore, by multiplexing the measurement report with the feedback message, a timing and/or other transmission parameters for the measurement report may be identified by the UE 120. However, when the measurement report is multiplexed with the feedback message, the base station 110 may need to determine the timing offset value (e.g., the K1 value) for the feedback message based at least in part on one or more capabilities of the UE 120. For example, the base station 110 may determine the timing offset value (e.g., the K1 value) for the feedback message based at least in part on a feedback processing capability of the UE 120 (e.g., an amount of time needed by the UE 120 to determine if a message has been successfully received and/or decoded) and based at least in part on a CSI processing capability of the UE 120 (e.g., an amount of time needed by the UE 120 to determine CSI or measurement values based at least in part on a received reference signal). For example, the CSI processing capability of the UE 120 may be associated with a greater amount of time than an amount of time associated with the feedback processing capability of the UE 120. Therefore, the base station 110 may determine the timing offset value (e.g., the K1 value) for the feedback message to ensure that a timing of the feedback message allows enough time for the UE 120 to perform CSI computations and/or processing. In other words, the base station 110 may determine the timing offset value (e.g., the K1 value) for the feedback message to be equal to or greater than both the amount of time associated with the feedback processing capability of the UE 120 and the amount of time associated with the CSI processing capability of the UE 120.

Additionally, the base station 110 may transmit, and the UE 120 may receive, a second scheduling grant for a second downlink message, where the second scheduling grant indicates second uplink control channel resources to be used to transmit second feedback information associated with the second downlink message (e.g., by indicating a second K2 value). The second downlink message may be scheduled to arrive at the UE 120 after the downlink message, but before the transmission of multiplexed feedback message and measurement report by the UE 120. For example, the timing offset for the multiplexed feedback message and measurement report may be larger to account for the CSI processing time of the UE 120. If the base station 110 were to determine the second K2 for the second downlink message based solely on the feedback processing capability of the UE 120, then the second feedback message may be scheduled to be transmitted prior to the multiplexed feedback message and measurement report. This may result in out of order feedback arriving at the base station 110 (e.g., because the first feedback arriving at the base station 110 may be associated with a second transmitted downlink message). Out of order feedback messages may increase decoding complexity and/or may increase a complexity for the base station 110 associating feedback with a given downlink message. Therefore, to ensure that the second feedback message is transmitted after the multiplexed feedback message and measurement report, the base station 110 may determine the second K2 value to ensure that the second feedback message is scheduled to be transmitted after the first feedback message (e.g., the multiplexed feedback message and measurement report) associated with the first downlink message.

In some aspects, the base station 110 may transmit, and the UE 120 may receive, a scheduling grant for a downlink message in a same message as the indication to switch the beam (e.g., a single DCI message may indicate the beam switch and may schedule a downlink message, such as the downlink message shown by reference number 730). The base station 110 may transmit, and the UE 120 may receive, the downlink message, where the downlink message indicates the one or more transmission parameters to be used for the measurement report. For example, the downlink message shown by reference number 730 may indicate a TDRA, an FDRA, and/or an MCS, among other examples, to be used by the UE 120 to transmit the measurement report.

As shown by reference number 740, the base station 110 may transmit, and the UE 120 may receive, one or more reference signals. For example, the reference signals may be signals to be measured by the UE 120 (e.g., as part of a beam measurement or a beam management procedure triggered by the beam switch indication). For example, the one or more reference signals may be CSI-RSs and/or TRSs, among other examples. The UE 120 may identify a timing of the transmission of a reference signal based at least in part on the configuration information (e.g., based at least in part on a CSI report configuration). In some aspects, the UE 120 may identify a timing of the transmission of a reference signal based at least in part on a timing of the DCI that includes the indication to switch the beam. For example, as shown in FIG. 7, a timing offset for the reference signal may be relative to the timing of the DCI that includes the indication to switch the beam. In some aspects, the timing offset for the reference signal may be relative to a timing of ACK feedback associated with the DCI that includes the indication to switch the beam.

As shown by reference number 745, the UE 120 may measure the one or more reference signals. For example, the UE 120 may perform RSRP, RSRQ, and/or other Layer 1 measurements of the one or more reference signals. In some aspects, the UE 120 may perform the measurements based at least in part on a CSI report configuration associated with the one or more reference signals. For example, the UE 120 may perform one or more measurements of a reference signal in accordance with a beam management procedure that is triggered by the beam switch indication.

As shown by reference number 750, the UE 120 may transmit, and the base station 110 may receive, a measurement report indicating one or more measurements of the reference signal(s). The UE 120 may use the one or more transmission parameters (e.g., identified as described above) to transmit the measurement report. For example, as shown in FIG. 7, the UE 120 may transmit the measurement report at a time indicated by a timing offset for the measurement report (e.g., a K2 value). The timing offset for the measurement report may be relative to a timing of the DCI that includes the indication to switch the beam. Alternatively, the timing offset for the measurement report may be relative to a timing of ACK feedback associated with the DCI that includes the indication to switch the beam. The timing offset may be indicated by the configuration information, the DCI that includes the beam switch indication, a MAC-CE message, another DCI message, another downlink message, and/or may be based at least in part on a rule, among other examples (e.g., as described in more detail elsewhere herein). Additionally, one or more other transmission parameters (such as an FDRA and/or an MCS) may be indicated by the configuration information, the DCI that includes the beam switch indication, a MAC-CE message, another DCI message, another downlink message, and/or may be based at least in part on a rule, among other examples (e.g., as described in more detail elsewhere herein).

In some aspects, the UE 120 may multiplex the measurement report with feedback information associated with the downlink message (e.g., the downlink message shown by reference number 730). The UE 120 may transmit, using uplink control channel resources associated with the feedback information, the measurement report multiplexed with the feedback information.

In this way, transmission parameters, such as a TDRA, an FDRA, and/or an MCS, among other examples, for a measurement report that is triggered by a beam switch indication may be identified by the UE 120, such as when the beam switch indication is included in DCI that uses a downlink DCI format (e.g., that may not include fields for scheduling uplink messages).

As a result, the UE 120 may be enabled to identify a configuration, a timing, and/or transmission parameters to be used to transmit the measurement report that is triggered by the beam switch indication. For example, DCI indicating the beam switch indication may use a downlink DCI format and the UE may still be enabled to identify a TDRA, an FDRA, and/or an MCS for the measurement report (e.g., when the measurement report is transmitted on the PUSCH). Therefore, a beam switch or a beam update and a measurement report (e.g., a CSI measurement report) may be triggered in a single message (e.g., conserving resources of the UE and the base station) and the UE 120 may be enabled to identify transmission parameters to be used to transmit the measurement report.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with a measurement report triggered by a beam switch indication.

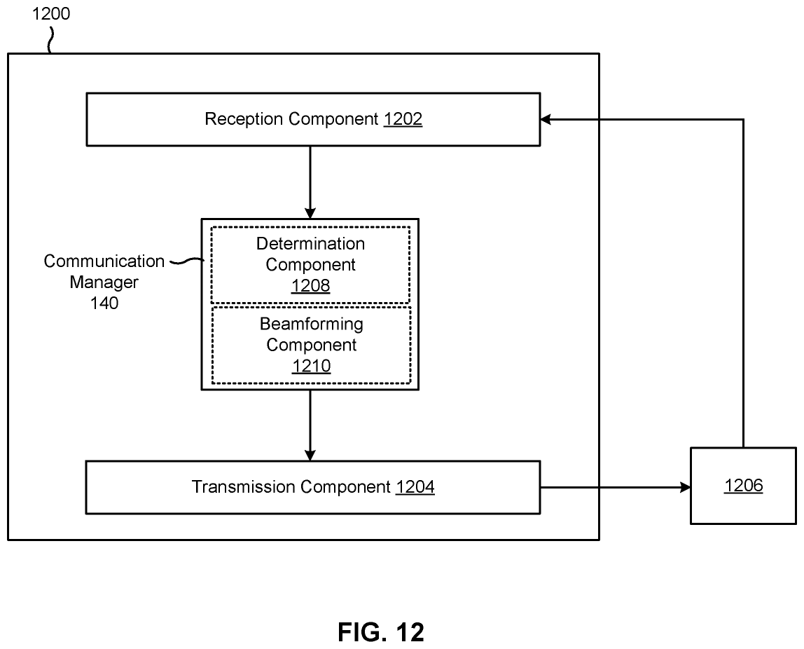

As shown in FIG. 8, in some aspects, process 800 may include receiving an indication to switch a beam used by the UE, wherein the indication triggers a beam measurement and a transmission of a measurement report (block 810). For example, the UE (e.g., using communication manager 140 and/or reception component 1202, depicted in FIG. 12) may receive an indication to switch a beam used by the UE, wherein the indication triggers a beam measurement and a transmission of a measurement report, as described above.

As further shown in FIG. 8, in some aspects, process 800 may include receiving a reference signal associated with the beam measurement based at least in part on receiving the indication to switch the beam (block 820). For example, the UE (e.g., using communication manager 140 and/or reception component 1202, depicted in FIG. 12) may receive a reference signal associated with the beam measurement based at least in part on receiving the indication to switch the beam, as described above.

As further shown in FIG. 8, in some aspects, process 800 may include transmitting, using one or more transmission parameters, the measurement report indicating a measurement of the reference signal, wherein the one or more transmission parameters are based at least in part on receiving the indication to switch the beam (block 830). For example, the UE (e.g., using communication manager 140 and/or transmission component 1204, depicted in FIG. 12) may transmit, using one or more transmission parameters, the measurement report indicating a measurement of the reference signal, wherein the one or more transmission parameters are based at least in part on receiving the indication to switch the beam, as described above.

Process 800 may include additional aspects, such as any single aspect or any combination of aspects described below and/or in connection with one or more other processes described elsewhere herein.

In a first aspect, the indication to switch the beam indicates a report configuration associated with the measurement report, and wherein the one or more transmission parameters are based at least in part on the report configuration.

In a second aspect, alone or in combination with the first aspect, process 800 includes receiving configuration information indicating one or more report configurations and indicating an association between one or more beams or TCI states and the one or more report configurations.

In a third aspect, alone or in combination with one or more of the first and second aspects, process 800 includes receiving configuration information indicating information for measurement reports to be transmitted using an uplink control channel, and wherein transmitting the measurement report includes transmitting the measurement report on the uplink control channel at a time indicated by a timing offset value that is indicated by the configuration information, wherein the timing offset value indicates an amount of time relative to receiving the indication to switch the beam.

In a fourth aspect, alone or in combination with one or more of the first through third aspects, transmitting the measurement report includes transmitting the measurement report on an uplink control channel based at least in part on the measurement report being triggered by the indication to switch the beam.

In a fifth aspect, alone or in combination with one or more of the first through fourth aspects, the measurement report is associated with an uplink shared channel, and receiving the indication to switch the beam includes receiving DCI including the indication to switch the beam, wherein the DCI uses an uplink DCI format, and wherein the DCI indicates the one or more transmission parameters.

In a sixth aspect, alone or in combination with one or more of the first through fifth aspects, the measurement report is associated with an uplink shared channel, and process 800 includes receiving a message indicating the one or more transmission parameters.

In a seventh aspect, alone or in combination with one or more of the first through sixth aspects, the message is an RRC message.

In an eighth aspect, alone or in combination with one or more of the first through seventh aspects, the message is a MAC-CE message.

In a ninth aspect, alone or in combination with one or more of the first through eighth aspects, process 800 includes receiving an indication of the one or more transmission parameters in a same downlink message as the indication to switch the beam.

In a tenth aspect, alone or in combination with one or more of the first through ninth aspects, at least one transmission parameter, of the one or more transmission parameters, is indicated via one or more rules.

In an eleventh aspect, alone or in combination with one or more of the first through tenth aspects, process 800 includes receiving RRC configuration information indicating one or more sets of transmission parameters for measurement reports triggered by beam switch indications, and receiving the indication to switch the beam includes receiving an indication of a set of transmission parameters, from the one or more sets of transmission parameters, to be used for the measurement report, wherein the set of transmission parameters includes the one or more transmission parameters.

In a twelfth aspect, alone or in combination with one or more of the first through eleventh aspects, process 800 includes receiving RRC configuration information indicating one or more TDRA tables, wherein a TDRA table, of the one or more TDRA tables, includes entries having downlink values and uplink values, and receiving the indication to switch the beam includes receiving an indication of an entry of the TDRA table, wherein the entry includes one or more downlink values and one or more uplink values, and wherein the one or more transmission parameters are indicated by the one or more uplink values.

In a thirteenth aspect, alone or in combination with one or more of the first through twelfth aspects, process 800 includes receiving a scheduling grant for a downlink message in a same message as the indication to switch the beam, wherein one or more transmission parameters for the downlink message are indicated by the one or more downlink values in the entry of the TDRA table.

In a fourteenth aspect, alone or in combination with one or more of the first through thirteenth aspects, process 800 includes receiving RRC configuration information indicating one or more TDRA tables, and receiving the indication to switch the beam includes receiving a first indication of a first entry of a first TDRA table, of the one or more TDRA tables, and a second indication of a second entry of a second TDRA table of the one or more TDRA tables, wherein the first entry indicates one or more transmission parameters for a downlink message, and wherein the second entry indicates the one or more transmission parameters for the measurement report.

In a fifteenth aspect, alone or in combination with one or more of the first through fourteenth aspects, the measurement report is an aperiodic measurement report, wherein the measurement report is associated with an uplink control channel, wherein the one or more transmission parameters include a timing offset value, and receiving the indication to switch the beam includes receiving an indication of the timing offset value indicating an amount of time from receiving the indication to switch the beam to transmitting the measurement report.

In a sixteenth aspect, alone or in combination with one or more of the first through fifteenth aspects, the measurement report is an aperiodic measurement report, wherein the measurement report is associated with an uplink control channel, wherein the one or more transmission parameters include a first timing offset value, and receiving the indication to switch the beam includes receiving an indication of a second timing offset value associated with transmitting feedback for a downlink message scheduled by the indication to switch the beam, wherein the first timing offset value is based at least in part on the second timing offset value.

In a seventeenth aspect, alone or in combination with one or more of the first through sixteenth aspects, process 800 includes receiving RRC configuration information indicating associations between timing offset values associated with transmitting feedback for downlink messages and timing offset values associated with transmitting measurement reports triggered by beam switch indications, and wherein the first timing offset value is identified from the RRC configuration information using the second timing offset value.

In an eighteenth aspect, alone or in combination with one or more of the first through seventeenth aspects, the measurement report is an aperiodic measurement report, wherein the measurement report is associated with an uplink control channel, and receiving the indication to switch the beam includes receiving a first scheduling grant for a first downlink message, wherein the first scheduling grant indicates first uplink control channel resources to be used to transmit first feedback information associated with the first downlink message, and transmitting the measurement report includes multiplexing the measurement report with the first feedback information associated with the first downlink message, and transmitting, using the first uplink control channel resources, the measurement report multiplexed with the first feedback information associated with the first downlink message.

In a nineteenth aspect, alone or in combination with one or more of the first through eighteenth aspects, receiving the indication to switch the beam includes receiving an indication of a first timing offset value indicating an amount of time between receiving the first downlink message and transmitting the first feedback information, wherein the first timing offset value is based at least in part on a capability of the UE.

In a twentieth aspect, alone or in combination with one or more of the first through nineteenth aspects, process 800 includes receiving a second scheduling grant for a second downlink message, wherein the second scheduling grant indicates second uplink control channel resources to be used to transmit second feedback information associated with the second downlink message, wherein a second timing offset value associated with the second feedback information schedules the second feedback information to be transmitted after the first feedback information associated with the first downlink message.

In a twenty-first aspect, alone or in combination with one or more of the first through twentieth aspects, process 800 includes receiving a scheduling grant for a downlink message in a same message as the indication to switch the beam, and receiving the downlink message, wherein the downlink message indicates the one or more transmission parameters for the measurement report.

In a twenty-second aspect, alone or in combination with one or more of the first through twenty-first aspects, the one or more transmission parameters include at least one of a time domain resource allocation for the measurement report, a frequency domain resource allocation for the measurement report, a modulation and coding scheme for the measurement report, or a HARQ process identifier associated with the measurement report.

In a twenty-third aspect, alone or in combination with one or more of the first through twenty-second aspects, receiving the indication to switch the beam includes receiving the indication to switch the beam via at least one of a DCI message or a MAC-CE message.

In a twenty-fourth aspect, alone or in combination with one or more of the first through twenty-third aspects, the measurement report is at least one of an aperiodic measurement report or a semi-persistent measurement report.

In a twenty-fifth aspect, alone or in combination with one or more of the first through twenty-fourth aspects, the reference signal is at least one of a CSI-RS or a tracking reference signal.

In a twenty-sixth aspect, alone or in combination with one or more of the first through twenty-fifth aspects, transmitting the measurement report includes transmitting the measurement report using an uplink control channel or an uplink shared channel.

In a twenty-seventh aspect, alone or in combination with one or more of the first through twenty-sixth aspects, the measurement report is a CSI report.

In a twenty-eighth aspect, alone or in combination with one or more of the first through twenty-seventh aspects, process 800 includes receiving configuration information indicating information for measurement reports to be transmitted using an uplink control channel; and transmitting acknowledgment feedback associated with the indication to switch the beam based at least in part on successfully receiving the indication to switch the beam, and transmitting the measurement report includes transmitting the measurement report on the uplink control channel at a time indicated by a timing offset value that is indicated by the configuration information, wherein the timing offset value indicates an amount of time relative to transmitting the acknowledgment feedback.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with a measurement report triggered by a beam switch indication.

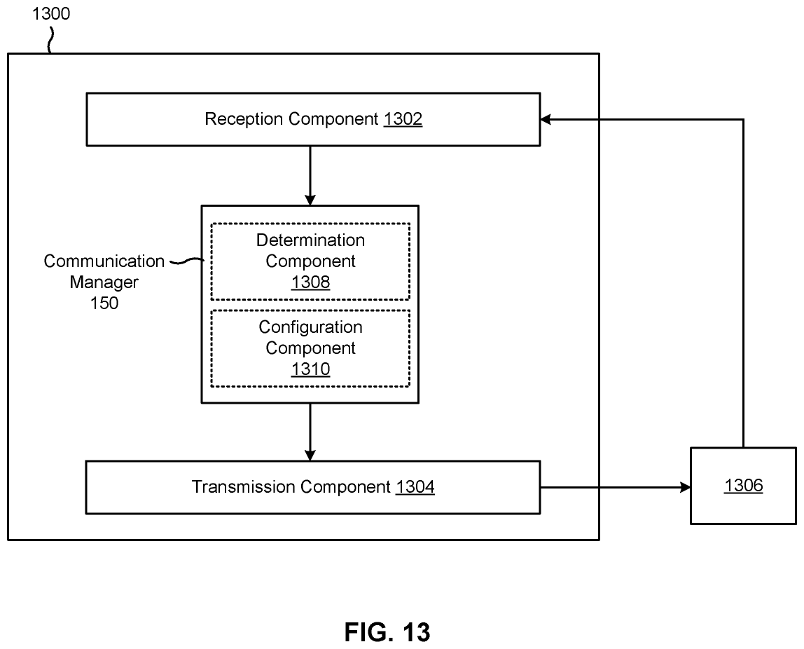

As shown in FIG. 9, in some aspects, process 900 may include transmitting, to a UE, an indication to switch a beam used by the UE, wherein the indication triggers a beam measurement and a transmission of a measurement report (block 910). For example, the base station (e.g., using communication manager 150 and/or transmission component 1304, depicted in FIG. 13) may transmit, to a UE, an indication to switch a beam used by the UE, wherein the indication triggers a beam measurement and a transmission of a measurement report, as described above.

As further shown in FIG. 9, in some aspects, process 900 may include transmitting a reference signal associated with the beam measurement based at least in part on transmitting the indication to switch the beam (block 920). For example, the base station (e.g., using communication manager 150 and/or transmission component 1304, depicted in FIG. 13) may transmit a reference signal associated with the beam measurement based at least in part on transmitting the indication to switch the beam, as described above.

As further shown in FIG. 9, in some aspects, process 900 may include receiving, using one or more transmission parameters, the measurement report indicating a measurement of the reference signal, wherein the one or more transmission parameters are based at least in part on the indication to switch the beam (block 930). For example, the base station (e.g., using communication manager 150 and/or reception component 1302, depicted in FIG. 13) may receive, using one or more transmission parameters, the measurement report indicating a measurement of the reference signal, wherein the one or more transmission parameters are based at least in part on the indication to switch the beam, as described above.

Process 900 may include additional aspects, such as any single aspect or any combination of aspects described below and/or in connection with one or more other processes described elsewhere herein.

In a first aspect, the indication to switch the beam indicates a report configuration associated with the measurement report, and wherein the one or more transmission parameters are based at least in part on the report configuration.

In a second aspect, alone or in combination with the first aspect, process 900 includes transmitting configuration information indicating one or more report configurations and indicating an association between one or more beams or TCI states and the one or more report configurations.

In a third aspect, alone or in combination with one or more of the first and second aspects, process 900 includes transmitting configuration information indicating information for measurement reports to be transmitted using an uplink control channel, and receiving the measurement report includes receiving the measurement report on the uplink control channel at a time indicated by a timing offset value that is indicated by the configuration information, wherein the timing offset value indicates an amount of time relative to receiving the indication to switch the beam.

In a fourth aspect, alone or in combination with one or more of the first through third aspects, receiving the measurement report includes receiving the measurement report on an uplink control channel based at least in part on the measurement report being triggered by the indication to switch the beam.

In a fifth aspect, alone or in combination with one or more of the first through fourth aspects, the measurement report is associated with an uplink shared channel, and transmitting the indication to switch the beam includes transmitting DCI including the indication to switch the beam, wherein the DCI uses an uplink DCI format, and wherein the DCI indicates the one or more transmission parameters.

In a sixth aspect, alone or in combination with one or more of the first through fifth aspects, the measurement report is associated with an uplink shared channel, and process 900 includes transmitting a message indicating the one or more transmission parameters.

In a seventh aspect, alone or in combination with one or more of the first through sixth aspects, the message is an RRC message. In an eighth aspect, alone or in combination with one or more of the first through seventh aspects, the message is a MAC-CE message.

In a ninth aspect, alone or in combination with one or more of the first through eighth aspects, process 900 includes transmitting an indication of the one or more transmission parameters in a same downlink message as the indication to switch the beam.

In a tenth aspect, alone or in combination with one or more of the first through ninth aspects, at least one transmission parameter, of the one or more transmission parameters, is indicated via one or more rules.

In an eleventh aspect, alone or in combination with one or more of the first through tenth aspects, process 900 includes transmitting RRC configuration information indicating one or more sets of transmission parameters for measurement reports triggered by beam switch indications, and transmitting the indication to switch the beam includes transmitting an indication of a set of transmission parameters, from the one or more sets of transmission parameters, to be used for the measurement report, wherein the set of transmission parameters includes the one or more transmission parameters.

In a twelfth aspect, alone or in combination with one or more of the first through eleventh aspects, process 900 includes transmitting RRC configuration information indicating one or more TDRA tables, wherein a TDRA table, of the one or more TDRA tables, includes entries having downlink values and uplink values, and transmitting the indication to switch the beam includes transmitting an indication of an entry of the TDRA table, wherein the entry includes one or more downlink values and one or more uplink values, and wherein the one or more transmission parameters are indicated by the one or more uplink values.

In a thirteenth aspect, alone or in combination with one or more of the first through twelfth aspects, process 900 includes transmitting a scheduling grant for a downlink message in a same message as the indication to switch the beam, wherein one or more transmission parameters for the downlink message are indicated by the one or more downlink values in the entry of the TDRA table.

In a fourteenth aspect, alone or in combination with one or more of the first through thirteenth aspects, process 900 includes transmitting RRC configuration information indicating one or more TDRA tables, and transmitting the indication to switch the beam includes transmitting a first indication of a first entry of a first TDRA table, of the one or more TDRA tables, and a second indication of a second entry of a second TDRA table of the one or more TDRA tables, wherein the first entry indicates one or more transmission parameters for a downlink message, and wherein the second entry indicates the one or more transmission parameters for the measurement report.

In a fifteenth aspect, alone or in combination with one or more of the first through fourteenth aspects, the measurement report is an aperiodic measurement report, wherein the measurement report is associated with an uplink control channel, wherein the one or more transmission parameters include a timing offset value, and transmitting the indication to switch the beam includes transmitting an indication of the timing offset value indicating an amount of time from receiving the indication to switch the beam to transmitting the measurement report.

In a sixteenth aspect, alone or in combination with one or more of the first through fifteenth aspects, the measurement report is an aperiodic measurement report, wherein the measurement report is associated with an uplink control channel, wherein the one or more transmission parameters include a first timing offset value, and transmitting the indication to switch the beam includes transmitting an indication of a second timing offset value associated with transmitting feedback for a downlink message scheduled by the indication to switch the beam, wherein the first timing offset value is based at least in part on the second timing offset value.

In a seventeenth aspect, alone or in combination with one or more of the first through sixteenth aspects, process 900 includes transmitting RRC configuration information indicating associations between timing offset values associated with transmitting feedback for downlink messages and timing offset values associated with transmitting measurement reports triggered by beam switch indications, and wherein the first timing offset value is selected from the RRC configuration information based at least in part on the second timing offset value.

In an eighteenth aspect, alone or in combination with one or more of the first through seventeenth aspects, the measurement report is an aperiodic measurement report, wherein the measurement report is associated with an uplink control channel, and transmitting the indication to switch the beam includes transmitting a first scheduling grant for a first downlink message, wherein the first scheduling grant indicates first uplink control channel resources to be used to transmit first feedback information associated with the first downlink message, and receiving the measurement report includes receiving, using the first uplink control channel resources, the measurement report multiplexed with the first feedback information associated with the first downlink message.

In a nineteenth aspect, alone or in combination with one or more of the first through eighteenth aspects, transmitting the indication to switch the beam includes transmitting an indication of a first timing offset value indicating an amount of time between receiving the first downlink message and transmitting the first feedback information, wherein the first timing offset value is based at least in part on a capability of the UE.

In a twentieth aspect, alone or in combination with one or more of the first through nineteenth aspects, process 900 includes transmitting a second scheduling grant for a second downlink message, wherein the second scheduling grant indicates second uplink control channel resources to be used to transmit second feedback information associated with the second downlink message, wherein a second timing offset value associated with the second feedback information schedules the second feedback information to be transmitted after the first feedback information associated with the first downlink message.

In a twenty-first aspect, alone or in combination with one or more of the first through twentieth aspects, process 900 includes transmitting a scheduling grant for a downlink message in a same message as the indication to switch the beam, and transmitting the downlink message, wherein the downlink message indicates the one or more transmission parameters for the measurement report.

In a twenty-second aspect, alone or in combination with one or more of the first through twenty-first aspects, the one or more transmission parameters include at least one of a time domain resource allocation for the measurement report, a frequency domain resource allocation for the measurement report, a modulation and coding scheme for the measurement report, or a HARQ process identifier associated with the measurement report.

In a twenty-third aspect, alone or in combination with one or more of the first through twenty-second aspects, transmitting the indication to switch the beam includes receiving the indication to switch the beam via at least one of a DCI message or a MAC-CE message.

In a twenty-fourth aspect, alone or in combination with one or more of the first through twenty-third aspects, the measurement report is at least one of an aperiodic measurement report or a semi-persistent measurement report.

In a twenty-fifth aspect, alone or in combination with one or more of the first through twenty-fourth aspects, the reference signal is at least one of a CSI-RS or a tracking reference signal.

In a twenty-sixth aspect, alone or in combination with one or more of the first through twenty-fifth aspects, receiving the measurement report includes receiving the measurement report using an uplink control channel or an uplink shared channel.

In a twenty-seventh aspect, alone or in combination with one or more of the first through twenty-sixth aspects, the measurement report is a CSI report.

In a twenty-eighth aspect, alone or in combination with one or more of the first through twenty-seventh aspects, process 900 includes transmitting configuration information indicating information for measurement reports to be transmitted using an uplink control channel; and receiving acknowledgment feedback associated with the indication to switch the beam based at least in part on successfully receiving the indication to switch the beam, and receiving the measurement report includes receiving the measurement report on the uplink control channel at a time indicated by a timing offset value that is indicated by the configuration information, wherein the timing offset value indicates an amount of time relative to transmitting the acknowledgment feedback.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

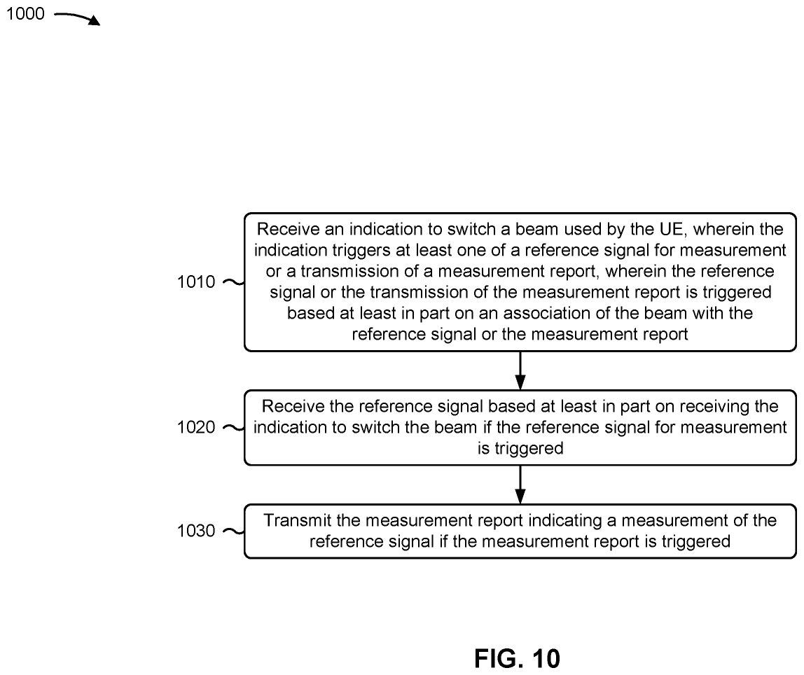

FIG. 10 is a diagram illustrating an example process 1000 performed, for example, by a UE, in accordance with the present disclosure. Example process 1000 is an example where the UE (e.g., UE 120) performs operations associated with an indication triggering a TCI update and measurement or reporting.

As shown in FIG. 10, in some aspects, process 1000 may include receiving an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report (block 1010). For example, the UE (e.g., using communication manager 140 and/or reception component 1202, depicted in FIG. 12) may receive an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report, as described above.

As further shown in FIG. 10, in some aspects, process 1000 may include receiving the reference signal based at least in part on receiving the indication to switch the beam if the reference signal for measurement is triggered (block 1020). For example, the UE (e.g., using communication manager 140 and/or reception component 1202, depicted in FIG. 12) may receive the reference signal based at least in part on receiving the indication to switch the beam if the reference signal for measurement is triggered, as described above.

As further shown in FIG. 10, in some aspects, process 1000 may include transmitting the measurement report indicating a measurement of the reference signal if the measurement report is triggered (block 1030). For example, the UE (e.g., using communication manager 140 and/or transmission component 1204, depicted in FIG. 12) may transmit the measurement report indicating a measurement of the reference signal if the measurement report is triggered, as described above.

Process 1000 may include additional aspects, such as any single aspect or any combination of aspects described below and/or in connection with one or more other processes described elsewhere herein.

In a first aspect, process 1000 includes receiving configuration information (e.g., configuration information shown by reference number 505, configuration information shown by reference number 505 and/or 605) configuring the association.

In a second aspect, alone or in combination with the first aspect, the configuration information is received via RRC signaling or MAC signaling, such as a MAC-CE.

In a third aspect, alone or in combination with one or more of the first and second aspects, process 1000 includes applying the configuration information after an activation period has elapsed based at least in part on the configuration information being received via MAC signaling. For example, the UE may apply the association after the activation period has elapsed.

In a fourth aspect, alone or in combination with one or more of the first through third aspects, the configuration information indicates that a TCI state of the beam is associated with a codepoint of a trigger state associated with the measurement report, and wherein the configuration information is provided via a TCI configuration information element in radio resource control signaling. For example, the trigger state may be configured as associated with a CSI report configuration of the measurement report.

In a fifth aspect, alone or in combination with one or more of the first through fourth aspects, the configuration information indicates that a TCI state of the beam is associated with a report configuration of the measurement report, and wherein the configuration information is provided via a TCI configuration information element in radio resource control signaling. For example, the association may be between a TCI state and a report configuration such as a CSI report configuration.

In a sixth aspect, alone or in combination with one or more of the first through fifth aspects, the association is based at least in part on a rule. The rule is described with regard to FIG. 6.

In a seventh aspect, alone or in combination with one or more of the first through sixth aspects, process 1000 includes receiving signaling activating the rule.

In an eighth aspect, alone or in combination with one or more of the first through seventh aspects, the signaling indicates an action associated with the measurement report. Examples of actions include P3 CSI-RS beam management (e.g., beam refinement for a receiver), measurement of a TRS, CSI measurement, and P2 CSI-RS beam management (e.g., beam refinement for a transmitter).

In a ninth aspect, alone or in combination with one or more of the first through eighth aspects, the signaling indicates whether the action is periodic, aperiodic, or semi-persistent.

In a tenth aspect, alone or in combination with one or more of the first through ninth aspects, the rule is preconfigured or specified in a wireless communication specification.

In an eleventh aspect, alone or in combination with one or more of the first through tenth aspects, the rule indicates the reference signal or the measurement report based at least in part on a source reference signal of the beam. The source reference signal may be defined by a TCI state of the beam.

In a twelfth aspect, alone or in combination with one or more of the first through eleventh aspects, the reference signal matches a reference signal type of the source reference signal. A reference signal type may include, for example, a P-TRS, an AP-TRS, a CSI-RS, or the like.

In a thirteenth aspect, alone or in combination with one or more of the first through twelfth aspects, the source reference signal is a periodic tracking reference signal and the reference signal is an aperiodic tracking reference signal associated with the periodic tracking reference signal.

In a fourteenth aspect, alone or in combination with one or more of the first through thirteenth aspects, the measurement report is associated with a measurement report configuration (e.g., a CSI report configuration) having a reference signal resource set (e.g., a CSI-RS resource set) to which the source reference signal belongs.

In a fifteenth aspect, alone or in combination with one or more of the first through fourteenth aspects, the reference signal resource set has repetition activated based at least in part on an action associated with the measurement report being a beam refinement for a receiver.

In a sixteenth aspect, alone or in combination with one or more of the first through fifteenth aspects, the reference signal resource set has repetition deactivated based at least in part on an action associated with the measurement report being a beam refinement for a transmitter.

In a seventeenth aspect, alone or in combination with one or more of the first through sixteenth aspects, the rule indicates the reference signal based at least in part on a TCI state of the beam. For example, the association may be between the reference signal (or a measurement report) and the TCI state.

In an eighteenth aspect, alone or in combination with one or more of the first through seventeenth aspects, the TCI state is associated with multiple QCL types corresponding to multiple source reference signals, and wherein the rule indicates the reference signal based at least in part on a selected QCL type, of the multiple QCL types, associated with a selected source reference signal.

In a nineteenth aspect, alone or in combination with one or more of the first through eighteenth aspects, the reference signal is associated with a reference signal resource (e.g., a CSI-RS resource) or a reference signal resource set (e.g., a CSI-RS resource set) that uses the TCI state (e.g., is configured with the TCI state).

In a twentieth aspect, alone or in combination with one or more of the first through nineteenth aspects, the reference signal resource set has repetition activated based at least in part on an action associated with the measurement report being a beam refinement for a receiver, and wherein all resources of the reference signal resource set are triggered for the reference signal.

In a twenty-first aspect, alone or in combination with one or more of the first through twentieth aspects, the reference signal resource set has repetition deactivated based at least in part on an action associated with the measurement report being a beam refinement for a transmitter, and wherein all resources of the reference signal resource set are triggered for the reference signal.

In a twenty-second aspect, alone or in combination with one or more of the first through twenty-first aspects, the measurement report is a beam management report.

In a twenty-third aspect, alone or in combination with one or more of the first through twenty-second aspects, the rule indicates a mapping of a transmission configuration indicator state with a reference signal resource or a reference signal resource set of the reference signal, and wherein the mapping is unique.

In a twenty-fourth aspect, alone or in combination with one or more of the first through twenty-third aspects, the rule indicates a mapping of a transmission configuration indicator state with one or more reference signal resources or reference signal resource sets of the reference signal, and wherein the mapping is based at least in part on a prioritization rule for reference signal resources or reference signal resource sets.

In a twenty-fifth aspect, alone or in combination with one or more of the first through twenty-fourth aspects, the reference signal is associated with a group of reference signal resource sets that are triggered by receiving the indication to switch the beam, wherein a TCI state of the group of reference signal resource sets is configured as undefined, and wherein the group of reference signal resource sets use a TCI state indicated by the indication to switch the beam. For example, the group of reference signal resource sets may have a floating TCI state.

In a twenty-sixth aspect, alone or in combination with one or more of the first through twenty-fifth aspects, a reporting configuration for the measurement report, associated with the group of reference signal resource sets, is activated by the indication to switch the beam.

In a twenty-seventh aspect, alone or in combination with one or more of the first through twenty-sixth aspects, a report quantity of a reporting configuration of the measurement report is configured as undefined, and wherein the rule indicates the report quantity based at least in part on an action associated with the measurement report. For example, the report configuration may have a floating quantity.

In a twenty-eighth aspect, alone or in combination with one or more of the first through twenty-seventh aspects, each reference signal resource set, of the group of reference signal resource sets, is associated with a respective action associated with the measurement report, and wherein each reference signal resource set is associated with a respective report quantity corresponding to the respective action.

In a twenty-ninth aspect, alone or in combination with one or more of the first through twenty-eighth aspects, the indication to switch the beam triggers transmission of an SRS using the beam.

In a thirtieth aspect, alone or in combination with one or more of the first through twenty-ninth aspects, process 1000 includes receiving configuration information indicating an association between a TCI state of the beam and a resource or resource set of the SRS.

In a thirty-first aspect, alone or in combination with one or more of the first through thirtieth aspects, a resource or resource set of the SRS is selected based at least in part on a rule indicating that the resource or resource set is based at least in part on a source reference signal of a TCI state of the beam.

In a thirty-second aspect, alone or in combination with one or more of the first through thirty-first aspects, a resource or resource set of the SRS is selected based at least in part on a rule indicating that the resource or resource set is based at least in part on a TCI state of the beam.

In a thirty-third aspect, alone or in combination with one or more of the first through thirty-second aspects, a resource or resource set of the SRS is selected based at least in part on a rule indicating a reference signal resource set that is triggered by receiving the indication to switch the beam, wherein a TCI state of the reference signal resource set is configured as undefined, and wherein the reference signal resource set uses a TCI state indicated by the indication to switch the beam.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

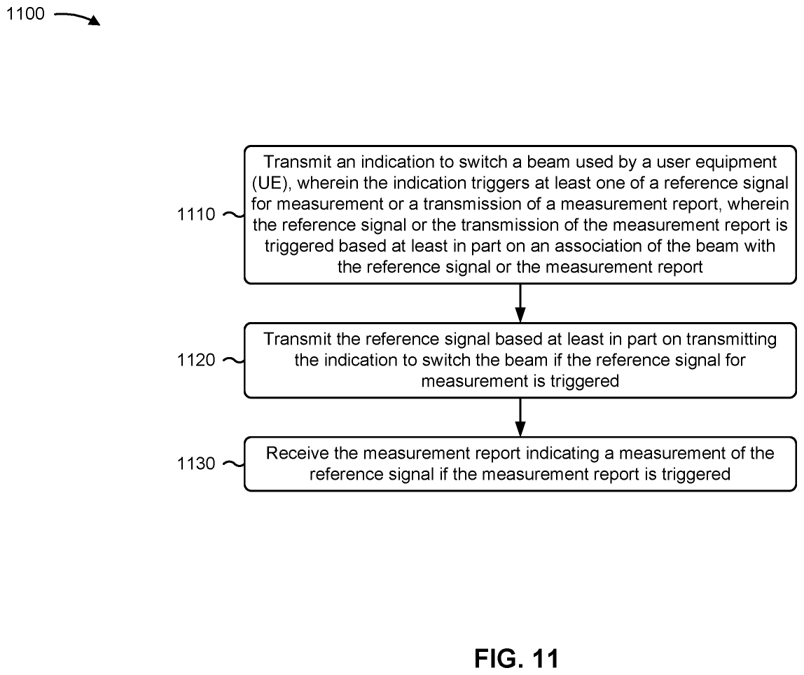

FIG. 11 is a diagram illustrating an example process 1100 performed, for example, by a base station, in accordance with the present disclosure. Example process 1100 is an example where the base station (e.g., base station 110) performs operations associated with an indication triggering a TCI state update and measurement or report.

As shown in FIG. 11, in some aspects, process 1100 may include transmitting an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report (block 1110). For example, the base station (e.g., using communication manager 150 and/or transmission component 1304, depicted in FIG. 13) may transmit an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report, as described above.

As further shown in FIG. 11, in some aspects, process 1100 may include transmitting the reference signal based at least in part on transmitting the indication to switch the beam if the reference signal for measurement is triggered (block 1120). For example, the base station (e.g., using communication manager 150 and/or transmission component 1304, depicted in FIG. 13) may transmit the reference signal based at least in part on transmitting the indication to switch the beam if the reference signal for measurement is triggered, as described above.

As further shown in FIG. 11, in some aspects, process 1100 may include receiving the measurement report indicating a measurement of the reference signal if the measurement report is triggered (block 1130). For example, the base station (e.g., using communication manager 150 and/or reception component 1302, depicted in FIG. 13) may receive the measurement report indicating a measurement of the reference signal if the measurement report is triggered, as described above.

Process 1100 may include additional aspects, such as any single aspect or any combination of aspects described below and/or in connection with one or more other processes described elsewhere herein.

In a first aspect, process 1100 includes transmitting configuration information configuring the association.

In a second aspect, alone or in combination with the first aspect, the configuration information is transmitted via RRC signaling or MAC signaling.

In a third aspect, alone or in combination with one or more of the first and second aspects, the configuration information is associated with an activation period based at least in part on the configuration information being transmitted via MAC signaling.

In a fourth aspect, alone or in combination with one or more of the first through third aspects, the configuration information indicates that a TCI state of the beam is associated with a codepoint of a trigger state associated with the measurement report, and wherein the configuration information is transmitted via a TCI configuration information element in radio resource control signaling.

In a fifth aspect, alone or in combination with one or more of the first through fourth aspects, the configuration information indicates that a TCI state of the beam is associated with a report configuration of the measurement report, and wherein the configuration information is transmitted via a TCI configuration information element in radio resource control signaling.

In a sixth aspect, alone or in combination with one or more of the first through fifth aspects, the association is based at least in part on a rule.

In a seventh aspect, alone or in combination with one or more of the first through sixth aspects, process 1100 includes transmitting signaling activating the rule.

In an eighth aspect, alone or in combination with one or more of the first through seventh aspects, the signaling indicates an action associated with the measurement report.

In a ninth aspect, alone or in combination with one or more of the first through eighth aspects, the signaling indicates whether the action is periodic, aperiodic, or semi-persistent.

In a tenth aspect, alone or in combination with one or more of the first through ninth aspects, the rule is preconfigured or specified in a wireless communication specification.

In an eleventh aspect, alone or in combination with one or more of the first through tenth aspects, the rule indicates the reference signal or the measurement report based at least in part on a source reference signal of the beam.

In a twelfth aspect, alone or in combination with one or more of the first through eleventh aspects, the reference signal matches a reference signal type of the source reference signal.

In a thirteenth aspect, alone or in combination with one or more of the first through twelfth aspects, the source reference signal is a periodic tracking reference signal and the reference signal is an aperiodic tracking reference signal associated with the periodic tracking reference signal.

In a fourteenth aspect, alone or in combination with one or more of the first through thirteenth aspects, the measurement report is associated with a measurement report configuration having a reference signal resource set to which the source reference signal belongs.

In a fifteenth aspect, alone or in combination with one or more of the first through fourteenth aspects, the reference signal resource set has repetition activated based at least in part on an action associated with the measurement report being a beam refinement for a receiver.

In a sixteenth aspect, alone or in combination with one or more of the first through fifteenth aspects, the reference signal resource set has repetition deactivated based at least in part on an action associated with the measurement report being a beam refinement for a transmitter.

In a seventeenth aspect, alone or in combination with one or more of the first through sixteenth aspects, the rule indicates the reference signal based at least in part on a TCI state of the beam.

In an eighteenth aspect, alone or in combination with one or more of the first through seventeenth aspects, the TCI state is associated with multiple QCL types corresponding to multiple source reference signals, and wherein the rule indicates the reference signal based at least in part on a selected QCL type, of the multiple QCL types, associated with a selected source reference signal.

In a nineteenth aspect, alone or in combination with one or more of the first through eighteenth aspects, the reference signal is associated with a reference signal resource or a reference signal resource set that uses the TCI state.

In a twentieth aspect, alone or in combination with one or more of the first through nineteenth aspects, the reference signal resource set has repetition activated based at least in part on an action associated with the measurement report being a beam refinement for a receiver, and wherein all resources of the reference signal resource set are triggered for the reference signal.

In a twenty-first aspect, alone or in combination with one or more of the first through twentieth aspects, the reference signal resource set has repetition deactivated based at least in part on an action associated with the measurement report being a beam refinement for a transmitter, and wherein all resources of the reference signal resource set are triggered for the reference signal.

In a twenty-second aspect, alone or in combination with one or more of the first through twenty-first aspects, the measurement report is a beam management report.

In a twenty-third aspect, alone or in combination with one or more of the first through twenty-second aspects, the rule indicates a mapping of a transmission configuration indicator state with a reference signal resource or a reference signal resource set of the reference signal, and wherein the mapping is unique.

In a twenty-fourth aspect, alone or in combination with one or more of the first through twenty-third aspects, the rule indicates a mapping of a transmission configuration indicator state with one or more reference signal resources or reference signal resource sets of the reference signal, and wherein the mapping is based at least in part on a prioritization rule for reference signal resources or reference signal resource sets.

In a twenty-fifth aspect, alone or in combination with one or more of the first through twenty-fourth aspects, the reference signal is associated with a group of reference signal resource sets that are triggered by receiving the indication to switch the beam, wherein a TCI state of the group of reference signal resource sets is configured as undefined, and wherein the group of reference signal resource sets use a TCI state indicated by the indication to switch the beam.

In a twenty-sixth aspect, alone or in combination with one or more of the first through twenty-fifth aspects, a reporting configuration for the measurement report, associated with the group of reference signal resource sets, is activated by the indication to switch the beam.

In a twenty-seventh aspect, alone or in combination with one or more of the first through twenty-sixth aspects, a report quantity of a reporting configuration of the measurement report is configured as undefined, and wherein the rule indicates the report quantity based at least in part on an action associated with the measurement report.

In a twenty-eighth aspect, alone or in combination with one or more of the first through twenty-seventh aspects, each reference signal resource set, of the group of reference signal resource sets, is associated with a respective action associated with the measurement report, and wherein each reference signal resource set is associated with a respective report quantity corresponding to the respective action.

In a twenty-ninth aspect, alone or in combination with one or more of the first through twenty-eighth aspects, the indication to switch the beam is configured to trigger transmission of an SRS using the beam.

In a thirtieth aspect, alone or in combination with one or more of the first through twenty-ninth aspects, process 1100 includes transmitting configuration information indicating an association between a TCI state of the beam and a resource or resource set of the SRS.

In a thirty-first aspect, alone or in combination with one or more of the first through thirtieth aspects, a resource or resource set of the SRS is based at least in part on a rule indicating that the resource or resource set is based at least in part on a source reference signal of a TCI state of the beam.

In a thirty-second aspect, alone or in combination with one or more of the first through thirty-first aspects, a resource or resource set of the SRS is based at least in part on a rule indicating that the resource or resource set is based at least in part on a TCI state of the beam.

In a thirty-third aspect, alone or in combination with one or more of the first through thirty-second aspects, a resource or resource set of the SRS is based at least in part on a rule indicating a reference signal resource set that is triggered by the indication to switch the beam, wherein a TCI state of the reference signal resource set is configured as undefined, and wherein the reference signal resource set uses a TCI state indicated by the indication to switch the beam.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a determination component 1208, and/or a beamforming component 1210, among other examples.

In some aspects, the apparatus 1200 may be configured to perform one or more operations described herein in connection with FIGS. 5-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

As mentioned above, the apparatus 1200 may be, or may be included in, a UE, such as the UE 120. The UE may include various components, which are shown in FIG. 2 and which are described in detail here. At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, an RSRQ parameter, and/or a CQI parameter, among other examples. In some examples, one or more components of the UE 120 may be included in a housing 284.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

The controller/processor 280 of the UE 120, and/or any other component(s) of FIGS. 2 and 12 may perform one or more techniques associated with a measurement report triggered by a beam switch indication, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving an indication to switch a beam used by the UE 120, wherein the indication triggers a beam measurement and a transmission of a measurement report; means for receiving a reference signal associated with the beam measurement based at least in part on receiving the indication to switch the beam; and/or means for transmitting, using one or more transmission parameters, the measurement report indicating a measurement of the reference signal, wherein the one or more transmission parameters are based at least in part on receiving the indication to switch the beam. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report; means for receiving the reference signal based at least in part on receiving the indication to switch the beam if the reference signal for measurement is triggered; or means for transmitting the measurement report indicating a measurement of the reference signal if the measurement report is triggered. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE depicted in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE depicted in connection with FIG. 2. In some aspects, the transmission component 1204 may be co-located with the reception component 1202 in a transceiver.

The reception component 1202 may receive an indication to switch a beam used by the UE, wherein the indication triggers a beam measurement and a transmission of a measurement report. The reception component 1202 may receive a reference signal associated with the beam measurement based at least in part on receiving the indication to switch the beam. The transmission component 1204 may transmit, using one or more transmission parameters, the measurement report indicating a measurement of the reference signal, wherein the one or more transmission parameters are based at least in part on receiving the indication to switch the beam.

The determination component 1208 may determine or identify the one or more transmission parameters to be used to transmit the measurement report.

The reception component 1202 may receive configuration information indicating one or more report configurations and indicating an association between one or more beams or TCI states and the one or more report configurations.

The reception component 1202 may receive configuration information indicating information for measurement reports to be transmitted using an uplink control channel.

The transmission component 1204 may transmit acknowledgment feedback associated with the indication to switch the beam based at least in part on successfully receiving the indication to switch the beam.

The reception component 1202 may receive configuration information indicating information for measurement reports to be transmitted using an uplink control channel.

The reception component 1202 may receive an indication of the one or more transmission parameters in a same downlink message as the indication to switch the beam.

The reception component 1202 may receive RRC configuration information indicating one or more sets of transmission parameters for measurement reports triggered by beam switch indications.

The reception component 1202 may receive RRC configuration information indicating one or more TDRA tables, wherein a TDRA table, of the one or more TDRA tables, includes entries having downlink values and uplink values.

The reception component 1202 may receive a scheduling grant for a downlink message in a same message as the indication to switch the beam, wherein one or more transmission parameters for the downlink message are indicated by the one or more downlink values in the entry of the TDRA table.

The reception component 1202 may receive RRC configuration information indicating one or more TDRA tables.

The reception component 1202 may receive RRC configuration information indicating associations between timing offset values associated with transmitting feedback for downlink messages and timing offset values associated with transmitting measurement reports triggered by beam switch indications, and wherein the first timing offset value is identified from the RRC configuration information using the second timing offset value.

The reception component 1202 may receive a second scheduling grant for a second downlink message, wherein the second scheduling grant indicates second uplink control channel resources to be used to transmit second feedback information associated with the second downlink message, wherein a second timing offset value associated with the second feedback information schedules the second feedback information to be transmitted after the first feedback information associated with the first downlink message.

The reception component 1202 may receive a scheduling grant for a downlink message in a same message as the indication to switch the beam.

The reception component 1202 may receive the downlink message, wherein the downlink message indicates the one or more transmission parameters for the measurement report.

The reception component 1202 may receive an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report. The reception component 1202 or the beamforming component 1210 may receive the reference signal based at least in part on receiving the indication to switch the beam if the reference signal for measurement is triggered. The transmission component 1204 may transmit the measurement report indicating a measurement of the reference signal if the measurement report is triggered.

The reception component 1202 may receive configuration information configuring the association.

The reception component 1202 may apply the configuration information after an activation period has elapsed based at least in part on the configuration information being received via MAC signaling.

The reception component 1202 may receive signaling activating the rule.

The reception component 1202 may receive configuration information indicating an association between a TCI state of the beam and a resource or resource set of the SRS.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a base station, or a base station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a determination component 1308, and/or a configuration component 1310, among other examples.

In some aspects, the apparatus 1300 may be configured to perform one or more operations described herein in connection with FIGS. 5-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the base station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the base station depicted in connection with FIG. 2.

As mentioned above, the apparatus 1300 may be, or may be included in, a base station, such as the base station 110. The base station may include various components, which are shown in FIG. 2 and which are described in detail here. At the base station 110, a transmit processor 220 may receive data, from a data source 212, intended for the UE 120 (or a set of UEs 120). The transmit processor 220 may select one or more MCSs for the UE 120 based at least in part on one or more CQIs received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a DMRS) and synchronization signals (e.g., a PSS or an SSS). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t. At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

The controller/processor 240 of the base station 110 and/or any other component(s) of FIGS. 2 and/or 13 may perform one or more techniques associated with a measurement report triggered by a beam switch indication, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the base station 110 and/or the apparatus 1300 includes means for transmitting, to a UE 120, an indication to switch a beam used by the UE, wherein the indication triggers a beam measurement and a transmission of a measurement report; means for transmitting a reference signal associated with the beam measurement based at least in part on transmitting the indication to switch the beam; and/or means for receiving, using one or more transmission parameters, the measurement report indicating a measurement of the reference signal, wherein the one or more transmission parameters are based at least in part on the indication to switch the beam. The means for the base station 110 or the apparatus 1300 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the base station 110 and/or the apparatus 1300 includes means for transmitting an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report; means for transmitting the reference signal based at least in part on transmitting the indication to switch the beam if the reference signal for measurement is triggered; or means for receiving the measurement report indicating a measurement of the reference signal if the measurement report is triggered. The means for the base station 110 and/or the apparatus 1300 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station depicted in connection with FIG. 2. In some aspects, the transmission component 1304 may be co-located with the reception component 1302 in a transceiver.

The transmission component 1304 may transmit, to a UE, an indication to switch a beam used by the UE, wherein the indication triggers a beam measurement and a transmission of a measurement report. The transmission component 1304 may transmit a reference signal associated with the beam measurement based at least in part on transmitting the indication to switch the beam. The reception component 1302 may receive, using one or more transmission parameters, the measurement report indicating a measurement of the reference signal, wherein the one or more transmission parameters are based at least in part on the indication to switch the beam.

The determination component 1308 may determine the one or more transmission parameters to be used by the UE to transmit the measurement report.

The transmission component 1304 may transmit configuration information indicating one or more report configurations and indicating an association between one or more beams or TCI states and the one or more report configurations.

The transmission component 1304 may transmit configuration information indicating information for measurement reports to be transmitted using an uplink control channel.

The reception component 1302 may receive acknowledgment feedback associated with the indication to switch the beam based at least in part on successfully receiving the indication to switch the beam.

The transmission component 1304 may transmit configuration information indicating information for measurement reports to be transmitted using an uplink control channel.

The transmission component 1304 may transmit an indication of the one or more transmission parameters in a same downlink message as the indication to switch the beam.

The transmission component 1304 may transmit RRC configuration information indicating one or more sets of transmission parameters for measurement reports triggered by beam switch indications.

The transmission component 1304 may transmit RRC configuration information indicating one or more TDRA tables, wherein a TDRA table, of the one or more TDRA tables, includes entries having downlink values and uplink values.

The transmission component 1304 may transmit a scheduling grant for a downlink message in a same message as the indication to switch the beam, wherein one or more transmission parameters for the downlink message are indicated by the one or more downlink values in the entry of the TDRA table.

The transmission component 1304 may transmit RRC configuration information indicating one or more TDRA tables.

The transmission component 1304 may transmit RRC configuration information indicating associations between timing offset values associated with transmitting feedback for downlink messages and timing offset values associated with transmitting measurement reports triggered by beam switch indications, and wherein the first timing offset value is selected from the RRC configuration information based at least in part on the second timing offset value.

The transmission component 1304 may transmit a second scheduling grant for a second downlink message, wherein the second scheduling grant indicates second uplink control channel resources to be used to transmit second feedback information associated with the second downlink message, wherein a second timing offset value associated with the second feedback information schedules the second feedback information to be transmitted after the first feedback information associated with the first downlink message. The determination component 1308 may determine the second timing offset value based at least in part on a capability of the UE.

The transmission component 1304 may transmit a scheduling grant for a downlink message in a same message as the indication to switch the beam.

The transmission component 1304 may transmit the downlink message, wherein the downlink message indicates the one or more transmission parameters for the measurement report.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the BS described in connection with FIG. 2. In some aspects, the transmission component 1304 may be co-located with the reception component 1302 in a transceiver.

The transmission component 1304 may transmit an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report. The transmission component 1304 may transmit the reference signal based at least in part on transmitting the indication to switch the beam if the reference signal for measurement is triggered. The reception component 1302 may receive the measurement report indicating a measurement of the reference signal if the measurement report is triggered.

The configuration component 1310 may transmit configuration information configuring the association.

The transmission component 1304 or the configuration component 1310 may transmit signaling activating the rule.

The configuration component 1310 may transmit configuration information indicating an association between a TCI state of the beam and a resource or resource set of the SRS.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving an indication to switch a beam used by the UE, wherein the indication triggers a beam measurement and a transmission of a measurement report; receiving a reference signal associated with the beam measurement based at least in part on receiving the indication to switch the beam; and transmitting, using one or more transmission parameters, the measurement report indicating a measurement of the reference signal, wherein the one or more transmission parameters are based at least in part on receiving the indication to switch the beam.

Aspect 2: The method of Aspect 1, wherein the indication to switch the beam indicates a report configuration associated with the measurement report, and wherein the one or more transmission parameters are based at least in part on the report configuration.

Aspect 3: The method of any of Aspects 1-2, further comprising: receiving configuration information indicating one or more report configurations and indicating an association between one or more beams or transmission configuration indicator (TCI) states and the one or more report configurations.

Aspect 4: The method of any of Aspects 1-3, further comprising: receiving configuration information indicating information for measurement reports to be transmitted using an uplink control channel; and transmitting acknowledgment feedback associated with the indication to switch the beam based at least in part on successfully receiving the indication to switch the beam, wherein transmitting the measurement report comprises: transmitting the measurement report on the uplink control channel at a time indicated by a timing offset value that is indicated by the configuration information, wherein the timing offset value indicates an amount of time relative to transmitting the acknowledgment feedback.

Aspect 5: The method of any of Aspects 1-4, further comprising: receiving configuration information indicating information for measurement reports to be transmitted using an uplink control channel; and wherein transmitting the measurement report comprises: transmitting the measurement report on the uplink control channel at a time indicated by a timing offset value that is indicated by the configuration information, wherein the timing offset value indicates an amount of time relative to receiving the indication to switch the beam.

Aspect 6: The method of any of Aspects 1-5, wherein transmitting the measurement report comprises: transmitting the measurement report on an uplink control channel based at least in part on the measurement report being triggered by the indication to switch the beam.

Aspect 7: The method of any of Aspects 1-6, wherein the measurement report is associated with an uplink shared channel, and wherein receiving the indication to switch the beam comprises: receiving downlink control information (DCI) including the indication to switch the beam, wherein the DCI uses an uplink DCI format, and wherein the DCI indicates the one or more transmission parameters.

Aspect 8: The method of any of Aspects 1-7, wherein the measurement report is associated with an uplink shared channel, the method further comprising: receiving a message indicating the one or more transmission parameters.

Aspect 9: The method of Aspect 8, wherein the message is a radio resource control (RRC) message.

Aspect 10: The method of Aspect 8, wherein the message is a medium access control (MAC) control element (MAC-CE) message.

Aspect 11: The method of any of Aspects 1-10, further comprising: receiving an indication of the one or more transmission parameters in a same downlink message as the indication to switch the beam.

Aspect 12: The method of any of Aspects 1-11, wherein at least one transmission parameter, of the one or more transmission parameters, is indicated via one or more rules.

Aspect 13: The method of any of Aspects 1-12, further comprising: receiving radio resource control (RRC) configuration information indicating one or more sets of transmission parameters for measurement reports triggered by beam switch indications; and wherein receiving the indication to switch the beam comprises: receiving an indication of a set of transmission parameters, from the one or more sets of transmission parameters, to be used for the measurement report, wherein the set of transmission parameters includes the one or more transmission parameters.

Aspect 14: The method of any of Aspects 1-13, further comprising: receiving radio resource control (RRC) configuration information indicating one or more time domain resource allocation (TDRA) tables, wherein a TDRA table, of the one or more TDRA tables, includes entries having downlink values and uplink values; and wherein receiving the indication to switch the beam comprises: receiving an indication of an entry of the TDRA table, wherein the entry includes one or more downlink values and one or more uplink values, and wherein the one or more transmission parameters are indicated by the one or more uplink values.

Aspect 15: The method of Aspect 14, further comprising: receiving a scheduling grant for a downlink message in a same message as the indication to switch the beam, wherein one or more transmission parameters for the downlink message are indicated by the one or more downlink values in the entry of the TDRA table.

Aspect 16: The method of any of Aspects 1-15, further comprising: receiving radio resource control (RRC) configuration information indicating one or more time domain resource allocation (TDRA) tables; and wherein receiving the indication to switch the beam comprises: receiving a first indication of a first entry of a first TDRA table, of the one or more TDRA tables, and a second indication of a second entry of a second TDRA table of the one or more TDRA tables, wherein the first entry indicates one or more transmission parameters for a downlink message, and wherein the second entry indicates the one or more transmission parameters for the measurement report.

Aspect 17: The method of any of Aspects 1-16, wherein the measurement report is an aperiodic measurement report, wherein the measurement report is associated with an uplink control channel, wherein the one or more transmission parameters include a timing offset value, and wherein receiving the indication to switch the beam comprises: receiving an indication of the timing offset value indicating an amount of time from receiving the indication to switch the beam to transmitting the measurement report.

Aspect 18: The method of any of Aspects 1-17, wherein the measurement report is an aperiodic measurement report, wherein the measurement report is associated with an uplink control channel, wherein the one or more transmission parameters include a first timing offset value, and wherein receiving the indication to switch the beam comprises: receiving an indication of a second timing offset value associated with transmitting feedback for a downlink message scheduled by the indication to switch the beam, wherein the first timing offset value is based at least in part on the second timing offset value.

Aspect 19: The method of Aspect 18, further comprising: receiving radio resource control (RRC) configuration information indicating associations between timing offset values associated with transmitting feedback for downlink messages and timing offset values associated with transmitting measurement reports triggered by beam switch indications, and wherein the first timing offset value is identified from the RRC configuration information using the second timing offset value.

Aspect 20: The method of any of Aspects 1-19, wherein the measurement report is an aperiodic measurement report, wherein the measurement report is associated with an uplink control channel, and wherein receiving the indication to switch the beam comprises: receiving a first scheduling grant for a first downlink message, wherein the first scheduling grant indicates first uplink control channel resources to be used to transmit first feedback information associated with the first downlink message; and wherein transmitting the measurement report comprises: multiplexing the measurement report with the first feedback information associated with the first downlink message; and transmitting, using the first uplink control channel resources, the measurement report multiplexed with the first feedback information associated with the first downlink message.

Aspect 21: The method of Aspect 20, wherein receiving the indication to switch the beam comprises: receiving an indication of a first timing offset value indicating an amount of time between receiving the first downlink message and transmitting the first feedback information, wherein the first timing offset value is based at least in part on a capability of the UE.

Aspect 22: The method of any of Aspects 20-21, further comprising: receiving a second scheduling grant for a second downlink message, wherein the second scheduling grant indicates second uplink control channel resources to be used to transmit second feedback information associated with the second downlink message, wherein a second timing offset value associated with the second feedback information schedules the second feedback information to be transmitted after the first feedback information associated with the first downlink message.

Aspect 23: The method of any of Aspects 1-22, further comprising: receiving a scheduling grant for a downlink message in a same message as the indication to switch the beam; and receiving the downlink message, wherein the downlink message indicates the one or more transmission parameters for the measurement report.

Aspect 24: The method of any of Aspects 1-23, wherein the one or more transmission parameters include at least one of: a time domain resource allocation for the measurement report, a frequency domain resource allocation for the measurement report, a modulation and coding scheme for the measurement report, or a hybrid automatic repeat request (HARQ) process identifier associated with the measurement report.

Aspect 25: The method of any of Aspects 1-24, wherein receiving the indication to switch the beam comprises: receiving the indication to switch the beam via at least one of a downlink control information (DCI) message or a medium access control (MAC) control element (MAC-CE) message.

Aspect 26: The method of any of Aspects 1-25, wherein the measurement report is at least one of an aperiodic measurement report or a semi-persistent measurement report.

Aspect 27: The method of any of Aspects 1-26, wherein the reference signal is at least one of a channel state information (CSI) reference signal (CSI-RS) or a tracking reference signal.

Aspect 28: The method of any of Aspects 1-27, wherein transmitting the measurement report comprises: transmitting the measurement report using an uplink control channel or an uplink shared channel.

Aspect 29: The method of any of Aspects 1-28, wherein the measurement report is a channel state information (CSI) report.

Aspect 30: A method of wireless communication performed by a base station, comprising: transmitting, to a user equipment (UE), an indication to switch a beam used by the UE, wherein the indication triggers a beam measurement and a transmission of a measurement report; transmitting a reference signal associated with the beam measurement based at least in part on transmitting the indication to switch the beam; and receiving, using one or more transmission parameters, the measurement report indicating a measurement of the reference signal, wherein the one or more transmission parameters are based at least in part on the indication to switch the beam.

Aspect 31: The method of Aspect 30, wherein the indication to switch the beam indicates a report configuration associated with the measurement report, and wherein the one or more transmission parameters are based at least in part on the report configuration.

Aspect 32: The method of any of Aspects 30-31, further comprising: transmitting configuration information indicating one or more report configurations and indicating an association between one or more beams or transmission configuration indicator (TCI) states and the one or more report configurations.

Aspect 33: The method of any of Aspects 30-32, further comprising: transmitting configuration information indicating information for measurement reports to be transmitted using an uplink control channel; and receiving acknowledgment feedback associated with the indication to switch the beam based at least in part on successfully receiving the indication to switch the beam, wherein receiving the measurement report comprises: receiving the measurement report on the uplink control channel at a time indicated by a timing offset value that is indicated by the configuration information, wherein the timing offset value indicates an amount of time relative to transmitting the acknowledgment feedback.

Aspect 34: The method of any of Aspects 30-33, further comprising: transmitting configuration information indicating information for measurement reports to be transmitted using an uplink control channel; and wherein receiving the measurement report comprises: receiving the measurement report on the uplink control channel at a time indicated by a timing offset value that is indicated by the configuration information, wherein the timing offset value indicates an amount of time relative to receiving the indication to switch the beam.

Aspect 35: The method of any of Aspects 30-34, wherein receiving the measurement report comprises: receiving the measurement report on an uplink control channel based at least in part on the measurement report being triggered by the indication to switch the beam.

Aspect 36: The method of any of Aspects 30-35, wherein the measurement report is associated with an uplink shared channel, and wherein transmitting the indication to switch the beam comprises: transmitting downlink control information (DCI) including the indication to switch the beam, wherein the DCI uses an uplink DCI format, and wherein the DCI indicates the one or more transmission parameters.

Aspect 37: The method of any of Aspects 30-36, wherein the measurement report is associated with an uplink shared channel, the method further comprising: transmitting a message indicating the one or more transmission parameters.

Aspect 38: The method of Aspect 37, wherein the message is a radio resource control (RRC) message.

Aspect 39: The method of Aspect 37, wherein the message is a medium access control (MAC) control element (MAC-CE) message.

Aspect 40: The method of any of Aspects 30-39, further comprising: transmitting an indication of the one or more transmission parameters in a same downlink message as the indication to switch the beam.

Aspect 41: The method of any of Aspects 30-40, wherein at least one transmission parameter, of the one or more transmission parameters, is indicated via one or more rules.

Aspect 42: The method of any of Aspects 30-41, further comprising: transmitting radio resource control (RRC) configuration information indicating one or more sets of transmission parameters for measurement reports triggered by beam switch indications; and wherein transmitting the indication to switch the beam comprises: transmitting an indication of a set of transmission parameters, from the one or more sets of transmission parameters, to be used for the measurement report, wherein the set of transmission parameters includes the one or more transmission parameters.

Aspect 43: The method of any of Aspects 30-42, further comprising: transmitting radio resource control (RRC) configuration information indicating one or more time domain resource allocation (TDRA) tables, wherein a TDRA table, of the one or more TDRA tables, includes entries having downlink values and uplink values; and wherein transmitting the indication to switch the beam comprises: transmitting an indication of an entry of the TDRA table, wherein the entry includes one or more downlink values and one or more uplink values, and wherein the one or more transmission parameters are indicated by the one or more uplink values.

Aspect 44: The method of Aspect 43, further comprising: transmitting a scheduling grant for a downlink message in a same message as the indication to switch the beam, wherein one or more transmission parameters for the downlink message are indicated by the one or more downlink values in the entry of the TDRA table.

Aspect 45: The method of any of Aspects 30-44, further comprising: transmitting radio resource control (RRC) configuration information indicating one or more time domain resource allocation (TDRA) tables; and wherein transmitting the indication to switch the beam comprises: transmitting a first indication of a first entry of a first TDRA table, of the one or more TDRA tables, and a second indication of a second entry of a second TDRA table of the one or more TDRA tables, wherein the first entry indicates one or more transmission parameters for a downlink message, and wherein the second entry indicates the one or more transmission parameters for the measurement report.

Aspect 46: The method of any of Aspects 30-45, wherein the measurement report is an aperiodic measurement report, wherein the measurement report is associated with an uplink control channel, wherein the one or more transmission parameters include a timing offset value, and wherein transmitting the indication to switch the beam comprises: transmitting an indication of the timing offset value indicating an amount of time from receiving the indication to switch the beam to transmitting the measurement report.

Aspect 47: The method of any of Aspects 30-46, wherein the measurement report is an aperiodic measurement report, wherein the measurement report is associated with an uplink control channel, wherein the one or more transmission parameters include a first timing offset value, and wherein transmitting the indication to switch the beam comprises: transmitting an indication of a second timing offset value associated with transmitting feedback for a downlink message scheduled by the indication to switch the beam, wherein the first timing offset value is based at least in part on the second timing offset value.

Aspect 48: The method of Aspect 47, further comprising: transmitting radio resource control (RRC) configuration information indicating associations between timing offset values associated with transmitting feedback for downlink messages and timing offset values associated with transmitting measurement reports triggered by beam switch indications, and wherein the first timing offset value is selected from the RRC configuration information based at least in part on the second timing offset value.

Aspect 49: The method of any of Aspects 30-48, wherein the measurement report is an aperiodic measurement report, wherein the measurement report is associated with an uplink control channel, and wherein transmitting the indication to switch the beam comprises: transmitting a first scheduling grant for a first downlink message, wherein the first scheduling grant indicates first uplink control channel resources to be used to transmit first feedback information associated with the first downlink message; and wherein receiving the measurement report comprises: receiving, using the first uplink control channel resources, the measurement report multiplexed with the first feedback information associated with the first downlink message.

Aspect 50: The method of Aspect 49, wherein transmitting the indication to switch the beam comprises: transmitting an indication of a first timing offset value indicating an amount of time between receiving the first downlink message and transmitting the first feedback information, wherein the first timing offset value is based at least in part on a capability of the UE.

Aspect 51: The method of any of Aspects 49-50, further comprising: transmitting a second scheduling grant for a second downlink message, wherein the second scheduling grant indicates second uplink control channel resources to be used to transmit second feedback information associated with the second downlink message, wherein a second timing offset value associated with the second feedback information schedules the second feedback information to be transmitted after the first feedback information associated with the first downlink message.

Aspect 52: The method of any of Aspects 30-51, further comprising: transmitting a scheduling grant for a downlink message in a same message as the indication to switch the beam; and transmitting the downlink message, wherein the downlink message indicates the one or more transmission parameters for the measurement report.

Aspect 53: The method of any of Aspects 30-52, wherein the one or more transmission parameters include at least one of: a time domain resource allocation for the measurement report, a frequency domain resource allocation for the measurement report, a modulation and coding scheme for the measurement report, or a hybrid automatic repeat request (HARQ) process identifier associated with the measurement report.

Aspect 54: The method of any of Aspects 30-53, wherein transmitting the indication to switch the beam comprises: receiving the indication to switch the beam via at least one of a downlink control information (DCI) message or a medium access control (MAC) control element (MAC-CE) message.

Aspect 55: The method of any of Aspects 30-54, wherein the measurement report is at least one of an aperiodic measurement report or a semi-persistent measurement report.

Aspect 56: The method of any of Aspects 30-55, wherein the reference signal is at least one of a channel state information (CSI) reference signal (CSI-RS) or a tracking reference signal.

Aspect 57: The method of any of Aspects 30-56, wherein receiving the measurement report comprises: receiving the measurement report using an uplink control channel or an uplink shared channel.

Aspect 58: The method of any of Aspects 30-57, wherein the measurement report is a channel state information (CSI) report.

Aspect 59: A method of wireless communication performed by a user equipment (UE), comprising: receiving an indication to switch a beam used by the UE, wherein the indication triggers at least one of a reference signal for measurement or a transmission of a measurement report, wherein the reference signal or the transmission of the measurement report is triggered based at least in part on an association of the beam with the reference signal or the measurement report; receiving the reference signal based at least in part on receiving the indication to switch the beam if the reference signal for measurement is triggered; or transmitting the measurement report indicating a measurement of the reference signal if the measurement report is triggered.

Aspect 60: The method of Aspect 59, further comprising: receiving configuration information configuring the association.

Aspect 61: The method of Aspect 60, wherein the configuration information is received via radio resource control (RRC) signaling or medium access control (MAC) signaling.

Aspect 62: The method of Aspect 60, further comprising: applying the configuration information after an activation period has elapsed based at least in part on the configuration information being received via MAC signaling.

Aspect 63: The method of Aspect 60, wherein the configuration information indicates that a transmission configuration indicator (TCI) state of the beam is associated with a codepoint of a trigger state associated with the measurement report, and wherein the configuration information is provided via a TCI configuration information element in radio resource control signaling.

Aspect 64: The method of Aspect 60, wherein the configuration information indicates that a transmission configuration indicator (TCI) state of the beam is associated with a report configuration of the measurement report, and wherein the configuration information is provided via a TCI configuration information element in radio resource control signaling.

Aspect 65: The method of any of Aspects 59-64, wherein the association is based at least in part on a rule.

Aspect 66: The method of Aspect 65, further comprising: receiving signaling activating the rule.

Aspect 67: The method of Aspect 66, wherein the signaling indicates an action associated with the measurement report.

Aspect 68: The method of Aspect 67, wherein the signaling indicates whether the action is periodic, aperiodic, or semi-persistent.

Aspect 69: The method of Aspect 65, wherein the rule is preconfigured or specified in a wireless communication specification.

Aspect 70: The method of Aspect 65, wherein the rule indicates the reference signal or the measurement report based at least in part on a source reference signal of the beam.

Aspect 71: The method of Aspect 70, wherein the reference signal matches a reference signal type of the source reference signal.

Aspect 72: The method of Aspect 70, wherein the source reference signal is a periodic tracking reference signal and the reference signal is an aperiodic tracking reference signal associated with the periodic tracking reference signal.

Aspect 73: The method of Aspect 70, wherein the measurement report is associated with a measurement report configuration having a reference signal resource set to which the source reference signal belongs.

Aspect 74: The method of Aspect 73, wherein the reference signal resource set has repetition activated based at least in part on an action associated with the measurement report being a beam refinement for a receiver.

Aspect 75: The method of Aspect 73, wherein the reference signal resource set has repetition deactivated based at least in part on an action associated with the measurement report being a beam refinement for a transmitter.

Aspect 76: The method of Aspect 65, wherein the rule indicates the reference signal based at least in part on a transmission configuration indicator (TCI) state of the beam.

Aspect 77: The method of Aspect 76, wherein the TCI state is associated with multiple quasi co-location (QCL) types corresponding to multiple source reference signals, and wherein the rule indicates the reference signal based at least in part on a selected QCL type, of the multiple QCL types, associated with a selected source reference signal.

Aspect 78: The method of Aspect 76, wherein the reference signal is associated with a reference signal resource or a reference signal resource set that uses the TCI state.

Aspect 79: The method of Aspect 78, wherein the reference signal resource set has repetition activated based at least in part on an action associated with the measurement report being a beam refinement for a receiver, and wherein all resources of the reference signal resource set are triggered for the reference signal.

Aspect 80: The method of Aspect 78, wherein the reference signal resource set has repetition deactivated based at least in part on an action associated with the measurement report being a beam refinement for a transmitter, and wherein all resources of the reference signal resource set are triggered for the reference signal.

Aspect 81: The method of Aspect 80, wherein the measurement report is a beam management report.

Aspect 82: The method of Aspect 65, wherein the rule indicates a mapping of a transmission configuration indicator state with a reference signal resource or a reference signal resource set of the reference signal, and wherein the mapping is unique.

Aspect 83: The method of Aspect 65, wherein the rule indicates a mapping of a transmission configuration indicator state with one or more reference signal resources or reference signal resource sets of the reference signal, and wherein the mapping is based at least in part on a prioritization rule for reference signal resources or reference signal resource sets.

Aspect 84: The method of Aspect 65, wherein the reference signal is associated with a group of reference signal resource sets that are triggered by receiving the indication to switch the beam, wherein a transmission configuration indicator (TCI) state of the group of reference signal resource sets is configured as undefined, and wherein the group of reference signal resource sets use a TCI state indicated by the indication to switch the beam.

Aspect 85: The method of Aspect 84, wherein a reporting configuration for the measurement report, associated with the group of reference signal resource sets, is activated by the indication to switch the beam.

Aspect 86: The method of Aspect 84, wherein a report quantity of a reporting configuration of the measurement report is configured as undefined, and wherein the rule indicates the report quantity based at least in part on an action associated with the measurement report.

Aspect 87: The method of Aspect 84, wherein each reference signal resource set, of the group of reference signal resource sets, is associated with a respective action associated with the measurement report, and wherein each reference signal resource set is associated with a respective report quantity corresponding to the respective action.

Aspect 88: The method of any of Aspects 59-87, wherein the indication to switch the beam triggers transmission of a sounding reference signal (SRS) using the beam.

Aspect 89: The method of Aspect 88, further comprising: receiving configuration information indicating an association between a transmission configuration indicator (TCI) state of the beam and a resource or resource set of the SRS.

Aspect 90: The method of Aspect 88, wherein a resource or resource set of the SRS is selected based at least in part on a rule indicating that the resource or resource set is based at least in part on a source reference signal of a transmission configuration indicator (TCI) state of the beam.

Aspect 91: The method of Aspect 88, wherein a resource or resource set of the SRS is selected based at least in part on a rule indicating that the resource or resource set is based at least in part on a transmission configuration indicator (TCI) state of the beam.

Aspect 92: The method of Aspect 88, wherein a resource or resource set of the SRS is selected based at least in part on a rule indicating a reference signal resource set that is triggered by receiving the indication to switch the beam, wherein a transmission configuration indicator (TCI) state of the reference signal resource set is configured as undefined, and wherein the reference signal resource set uses a TCI state indicated by the indication to switch the beam.

Aspect 93: A method of wireless communication performed by a base station, comprising: transmitting an indication to switch a beam used by a user equipment (UE), wherein the indication triggers at least one of a reference signal for measurement or a transmission of a measurement report, wherein the reference signal or the transmission of the measurement report is triggered based at least in part on an association of the beam with the reference signal or the measurement report; transmitting the reference signal based at least in part on transmitting the indication to switch the beam if the reference signal for measurement is triggered; or receiving the measurement report indicating a measurement of the reference signal if the measurement report is triggered.

Aspect 94: The method of Aspect 93, further comprising: transmitting configuration information configuring the association.

Aspect 95: The method of Aspect 94, wherein the configuration information is transmitted via radio resource control (RRC) signaling or medium access control (MAC) signaling.

Aspect 96: The method of Aspect 94, wherein the configuration information is associated with an activation period based at least in part on the configuration information being transmitted via MAC signaling.

Aspect 97: The method of Aspect 94, wherein the configuration information indicates that a transmission configuration indicator (TCI) state of the beam is associated with a codepoint of a trigger state associated with the measurement report, and wherein the configuration information is transmitted via a TCI configuration information element in radio resource control signaling.

Aspect 98: The method of Aspect 94, wherein the configuration information indicates that a transmission configuration indicator (TCI) state of the beam is associated with a report configuration of the measurement report, and wherein the configuration information is transmitted via a TCI configuration information element in radio resource control signaling.

Aspect 99: The method of any of Aspects 93-98, wherein the association is based at least in part on a rule.

Aspect 100: The method of Aspect 99, further comprising: transmitting signaling activating the rule.

Aspect 101: The method of Aspect 100, wherein the signaling indicates an action associated with the measurement report.

Aspect 102: The method of Aspect 101, wherein the signaling indicates whether the action is periodic, aperiodic, or semi-persistent.

Aspect 103: The method of Aspect 99, wherein the rule is preconfigured or specified in a wireless communication specification.

Aspect 104: The method of Aspect 99, wherein the rule indicates the reference signal or the measurement report based at least in part on a source reference signal of the beam.

Aspect 105: The method of Aspect 104, wherein the reference signal matches a reference signal type of the source reference signal.

Aspect 106: The method of Aspect 104, wherein the source reference signal is a periodic tracking reference signal and the reference signal is an aperiodic tracking reference signal associated with the periodic tracking reference signal.

Aspect 107: The method of Aspect 104, wherein the measurement report is associated with a measurement report configuration having a reference signal resource set to which the source reference signal belongs.

Aspect 108: The method of Aspect 107, wherein the reference signal resource set has repetition activated based at least in part on an action associated with the measurement report being a beam refinement for a receiver.

Aspect 109: The method of Aspect 107, wherein the reference signal resource set has repetition deactivated based at least in part on an action associated with the measurement report being a beam refinement for a transmitter.

Aspect 110: The method of Aspect 99, wherein the rule indicates the reference signal based at least in part on a transmission configuration indicator (TCI) state of the beam.

Aspect 111: The method of Aspect 110, wherein the TCI state is associated with multiple quasi co-location (QCL) types corresponding to multiple source reference signals, and wherein the rule indicates the reference signal based at least in part on a selected QCL type, of the multiple QCL types, associated with a selected source reference signal.

Aspect 112: The method of Aspect 110, wherein the reference signal is associated with a reference signal resource or a reference signal resource set that uses the TCI state.

Aspect 113: The method of Aspect 112, wherein the reference signal resource set has repetition activated based at least in part on an action associated with the measurement report being a beam refinement for a receiver, and wherein all resources of the reference signal resource set are triggered for the reference signal.

Aspect 114: The method of Aspect 112, wherein the reference signal resource set has repetition deactivated based at least in part on an action associated with the measurement report being a beam refinement for a transmitter, and wherein all resources of the reference signal resource set are triggered for the reference signal.

Aspect 115: The method of Aspect 114, wherein the measurement report is a beam management report.

Aspect 116: The method of Aspect 99, wherein the rule indicates a mapping of a transmission configuration indicator state with a reference signal resource or a reference signal resource set of the reference signal, and wherein the mapping is unique.

Aspect 117: The method of Aspect 99, wherein the rule indicates a mapping of a transmission configuration indicator state with one or more reference signal resources or reference signal resource sets of the reference signal, and wherein the mapping is based at least in part on a prioritization rule for reference signal resources or reference signal resource sets.

Aspect 118: The method of Aspect 99, wherein the reference signal is associated with a group of reference signal resource sets that are triggered by receiving the indication to switch the beam, wherein a transmission configuration indicator (TCI) state of the group of reference signal resource sets is configured as undefined, and wherein the group of reference signal resource sets use a TCI state indicated by the indication to switch the beam.

Aspect 119: The method of Aspect 118, wherein a reporting configuration for the measurement report, associated with the group of reference signal resource sets, is activated by the indication to switch the beam.

Aspect 120: The method of Aspect 118, wherein a report quantity of a reporting configuration of the measurement report is configured as undefined, and wherein the rule indicates the report quantity based at least in part on an action associated with the measurement report.

Aspect 121: The method of Aspect 118, wherein each reference signal resource set, of the group of reference signal resource sets, is associated with a respective action associated with the measurement report, and wherein each reference signal resource set is associated with a respective report quantity corresponding to the respective action.

Aspect 122: The method of any of Aspects 93-121, wherein the indication to switch the beam is configured to trigger transmission of a sounding reference signal (SRS) using the beam.

Aspect 123: The method of Aspect 122, further comprising: transmitting configuration information indicating an association between a transmission configuration indicator (TCI) state of the beam and a resource or resource set of the SRS.

Aspect 124: The method of Aspect 122, wherein a resource or resource set of the SRS is based at least in part on a rule indicating that the resource or resource set is based at least in part on a source reference signal of a transmission configuration indicator (TCI) state of the beam.

Aspect 125: The method of Aspect 122, wherein a resource or resource set of the SRS is based at least in part on a rule indicating that the resource or resource set is based at least in part on a transmission configuration indicator (TCI) state of the beam.

Aspect 126: The method of Aspect 122, wherein a resource or resource set of the SRS is based at least in part on a rule indicating a reference signal resource set that is triggered by the indication to switch the beam, wherein a transmission configuration indicator (TCI) state of the reference signal resource set is configured as undefined, and wherein the reference signal resource set uses a TCI state indicated by the indication to switch the beam.

Aspect 127: An apparatus for wireless communication at a device, comprising a processor; memory coupled with the processor; and instructions stored in the memory and executable by the processor to cause the apparatus to perform the method of one or more of Aspects 1-29 and/or 59-92.

Aspect 128: A device for wireless communication, comprising a memory and one or more processors coupled to the memory, the one or more processors configured to perform the method of one or more of Aspects 1-29 and/or 59-92.

Aspect 129: An apparatus for wireless communication, comprising at least one means for performing the method of one or more of Aspects 1-29 and/or 59-92.

Aspect 130: A non-transitory computer-readable medium storing code for wireless communication, the code comprising instructions executable by a processor to perform the method of one or more of Aspects 1-29 and/or 59-92.

Aspect 131: A non-transitory computer-readable medium storing a set of instructions for wireless communication, the set of instructions comprising one or more instructions that, when executed by one or more processors of a device, cause the device to perform the method of one or more of Aspects 1-29 and/or 59-92.

Aspect 132: An apparatus for wireless communication at a device, comprising a processor; memory coupled with the processor; and instructions stored in the memory and executable by the processor to cause the apparatus to perform the method of one or more of Aspects 30-58 and/or 93-126.

Aspect 133: A device for wireless communication, comprising a memory and one or more processors coupled to the memory, the one or more processors configured to perform the method of one or more of Aspects 30-58 and/or 93-126.

Aspect 134: An apparatus for wireless communication, comprising at least one means for performing the method of one or more of Aspects 30-58 and/or 93-126.

Aspect 135: A non-transitory computer-readable medium storing code for wireless communication, the code comprising instructions executable by a processor to perform the method of one or more of Aspects 30-58 and/or 93-126.

Aspect 136: A non-transitory computer-readable medium storing a set of instructions for wireless communication, the set of instructions comprising one or more instructions that, when executed by one or more processors of a device, cause the device to perform the method of one or more of Aspects 30-58 and/or 93-126.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving an indication to switch a beam used by the UE, wherein the indication triggers at least one of a reference signal for a beam measurement or a transmission of a measurement report, wherein the reference signal or the transmission of the measurement report is triggered based at least in part on an association of the beam with the reference signal or the measurement report;
receiving the reference signal associated with the beam measurement based at least in part on receiving the indication to switch the beam; and
transmitting, using one or more transmission parameters, the measurement report indicating a measurement of the reference signal, wherein the one or more transmission parameters are based at least in part on receiving the indication to switch the beam.

2. The method of claim 1, further comprising:
receiving configuration information indicating information for measurement reports to be transmitted using an uplink control channel; and
transmitting acknowledgment feedback associated with the indication to switch the beam based at least in part on successfully receiving the indication to switch the beam, wherein transmitting the measurement report comprises:
transmitting the measurement report on the uplink control channel at a time indicated by a timing offset value that is indicated by the configuration information,
wherein the timing offset value indicates an amount of time relative to transmitting the acknowledgment feedback.

3. The method of claim 1, further comprising:
receiving configuration information indicating information for measurement reports to be transmitted using an uplink control channel; and
wherein transmitting the measurement report comprises:
transmitting the measurement report on the uplink control channel at a time indicated by a timing offset value that is indicated by the configuration information,
wherein the timing offset value indicates an amount of time relative to receiving the indication to switch the beam.

4. The method of claim 1, wherein the measurement report is associated with an uplink shared channel, and wherein receiving the indication to switch the beam comprises:
receiving downlink control information (DCI) including the indication to switch the beam, wherein the DCI uses an uplink DCI format, and wherein the DCI indicates the one or more transmission parameters.

5. The method of claim 1, wherein the measurement report is associated with an uplink shared channel, the method further comprising:
receiving a message indicating the one or more transmission parameters.

6. The method of claim 1, further comprising:
receiving an indication of the one or more transmission parameters in a same downlink message as the indication to switch the beam.

7. The method of claim 1, wherein at least one transmission parameter, of the one or more transmission parameters, is indicated via one or more rules.

8. The method of claim 1, wherein the measurement report is an aperiodic measurement report, wherein the measurement report is associated with an uplink control channel, wherein the one or more transmission parameters include a timing offset value, and wherein receiving the indication to switch the beam comprises:
receiving an indication of the timing offset value indicating an amount of time from receiving the indication to switch the beam to transmitting the measurement report.

9. The method of claim 1, further comprising:
receiving a scheduling grant for a downlink message in a same message as the indication to switch the beam; and
receiving the downlink message, wherein the downlink message indicates the one or more transmission parameters for the measurement report.

10. The method of claim 1, further comprising:
receiving configuration information configuring the association.

11. The method of claim 10, wherein the configuration information indicates that at least one of:
a transmission configuration indicator (TCI) state of the beam is associated with a codepoint of a trigger state associated with the measurement report, and wherein the configuration information is provided via a TCI configuration information element in radio resource control signaling, or
a TCI state of the beam is associated with a report configuration of the measurement report, and wherein the configuration information is provided via a TCI configuration information element in radio resource control signaling.

12. The method of claim 1, wherein the association is based at least in part on a rule.

13. The method of claim 12, wherein the rule indicates the reference signal or the measurement report based at least in part on at least one of:
a source reference signal of the beam,
a transmission configuration indicator (TCI) state of the beam, or
a mapping of the TCI state with a reference signal resource associated with the reference signal or a reference signal resource set associated with the reference signal.

14. The method of claim 13, wherein the mapping is based at least in part on a prioritization rule.

15. A method of wireless communication performed by a base station, comprising:
transmitting, to a user equipment (UE), an indication to switch a beam used by the UE, wherein the indication triggers at least one of a reference signal for a beam measurement or a transmission of a measurement report, wherein the reference signal or the transmission of the measurement report is triggered based at least in part on an association of the beam with the reference signal or the measurement report;
transmitting the reference signal associated with the beam measurement based at least in part on transmitting the indication to switch the beam; and
receiving, using one or more transmission parameters, the measurement report indicating a measurement of the reference signal, wherein the one or more transmission parameters are based at least in part on the indication to switch the beam.

16. The method of claim 15, further comprising:
transmitting configuration information indicating information for measurement reports to be transmitted using an uplink control channel; and
receiving acknowledgment feedback associated with the indication to switch the beam based at least in part on successfully receiving the indication to switch the beam,
wherein receiving the measurement report comprises:
receiving the measurement report on the uplink control channel at a time indicated by a timing offset value that is indicated by the configuration information,
wherein the timing offset value indicates an amount of time relative to transmitting the acknowledgment feedback.

17. The method of claim 15, wherein the measurement report is associated with an uplink shared channel, the method further comprising:
transmitting a message indicating the one or more transmission parameters.

18. The method of claim 15, further comprising:
transmitting an indication of the one or more transmission parameters in a same downlink message as the indication to switch the beam.

19. The method of claim 15, wherein at least one transmission parameter, of the one or more transmission parameters, is indicated via one or more rules.

20. The method of claim 15, further comprising:
transmitting configuration information configuring the association.

21. The method of claim 20, wherein the configuration information is associated with an activation period based at least in part on the configuration information being transmitted via medium access control (MAC) signaling.

22. The method of claim 20, wherein the configuration information indicates that a transmission configuration indicator (TCI) state of the beam is associated with a report configuration of the measurement report, and wherein the configuration information is transmitted via a TCI configuration information element in radio resource control signaling.

23. The method of claim 15, wherein the association is based at least in part on a rule.

24. The method of claim 23, further comprising:
transmitting signaling activating the rule, wherein the signaling indicates an action associated with the measurement report.

25. The method of claim 23, wherein the rule indicates the reference signal based at least in part on a transmission configuration indicator (TCI) state of the beam.

26. The method of claim 25, wherein the TCI state is associated with multiple quasi co-location (QCL) types corresponding to multiple source reference signals, and wherein the rule indicates the reference signal based at least in part on a selected QCL type, of the multiple QCL types, associated with a selected source reference signal.

27. The method of claim 15, wherein the indication to switch the beam is configured to trigger transmission of a sounding reference signal (SRS) using the beam.

28. The method of claim 27, wherein a resource or resource set of the SRS is based at least in part on a rule indicating that at least one of:
the resource or the resource set is based at least in part on a source reference signal of a first transmission configuration indicator (TCI) state of the beam, or the resource or the resource set is based at least in part on a second TCI state of the beam.

29. A user equipment (UE) for wireless communication, comprising:
a memory; and
one or more processors, coupled to the memory, configured to:
receive an indication to switch a beam used by the UE, wherein the indication triggers at least one of a reference signal for a beam measurement or a transmission of a measurement report, wherein the reference signal or the transmission of the measurement report is triggered based at least in part on an association of the beam with the reference signal or the measurement report;
receive the reference signal associated with the beam measurement based at least in part on receiving the indication to switch the beam; and
transmit, using one or more transmission parameters, the measurement report indicating a measurement of the reference signal, wherein the one or more transmission parameters are based at least in part on receiving the indication to switch the beam.

30. A base station for wireless communication, comprising:
a memory; and
one or more processors, coupled to the memory, configured to:
transmit, to a user equipment (UE), an indication to switch a beam used by the UE, wherein the indication triggers at least one of a reference signal for a beam measurement or a transmission of a measurement report, wherein the reference signal or the transmission of the measurement report is triggered based at least in part on an association of the beam with the reference signal or the measurement report;
transmit the reference signal associated with the beam measurement based at least in part on transmitting the indication to switch the beam; and
receive, using one or more transmission parameters, the measurement report indicating a measurement of the reference signal, wherein the one or more transmission parameters are based at least in part on the indication to switch the beam.
